(19) United States
(12) Patent Application Publication
(10) Pub. No.: US 2025/0209571 A1
(43) Pub. Date: Jun. 26, 2025

(54) RISK MONITORING SYSTEM WITH SYNTHETIC TRAINING IMAGE GENERATION AND BLENDING USING GENERATIVE ARTIFICIAL INTELLIGENCE

(71) Applicant: Tyco Fire & Security GmbH, Neuhausen am Rheinfall (CH)

(72) Inventors: Premanand Kumar, Toronto (CA); Kshitij Judah, Brentwood, CA (US); Krzysztof Duszak, San Jose, CA (US); Krishnamurthy Selvaraj, Büchen (DE); Rajiv Ramanasankaran, San Jose, CA (US)

(21) Appl. No.: 18/771,622

(22) Filed: Jul. 12, 2024

Related U.S. Application Data
(60) Provisional application No. 63/614,179, filed on Dec. 22, 2023.

(51) Int. Cl. G06T 5/50; G06T 7/13; G06T 11/00; G06V 20/40; G06V 20/52; G06V 20/70

(52) U.S. Cl. CPC G06T 5/50; G06T 7/13; G06T 11/00; G06V 20/44; G06V 20/52; G06V 20/70; G06T 2207/20084; G06T 2207/20221

(57) ABSTRACT

Systems and methods are disclosed relating to generating synthetic training data for artificial intelligence-based event detection and/or risk monitoring. An exemplary method performed by one or more processors includes obtaining a background image of a building/work site, obtaining a subject image depicting a subject event, generating a blended image by combining the subject image with the background image using a generative artificial intelligence (AI) model, the blended image depicting the subject event occurring at the building/work site, and providing the blended image as training data input to at least one neural network to configure the at least one neural network using the blended image.

### CROSS-REFERENCE TO RELATED PATENT APPLICATION

This application claims priority to U.S. Provisional Patent Application No. 63/614,179, filed Dec. 22, 2023, the entire disclosure of which is incorporated by reference herein.

### BACKGROUND

The present disclosure relates generally to a building system of a building. The present disclosure relates more particularly to systems for managing and processing data of the building system.

Various interactions between building systems, components of building systems, users, technicians, and/or devices managed by users or technicians can present various risks to the building systems, users, technicians, and/or devices. However, it can be difficult to identify these risks. It can be especially difficult to identify low-frequency risks that are not commonly observed.

Generative artificial intelligence (AI) models can be used to create synthetic images depicting events specified via prompts. However, some generative AI models are programmed to prevent certain types of events from being depicted. Thus, it can be difficult to generate sufficient training data required to train a model to identify these types of events due to limited availability of training images, either natural or synthetic.

### SUMMARY

One or more aspects relate to building management systems and methods that implement risk identification. For example, a system can include at least one machine learning model configured using training data that includes at least one of unstructured data or structured data regarding items of equipment. The system can provide inputs, such as prompts, to the at least one machine learning model regarding a risk, and generate, according to the inputs, images and/or video regarding the risk, such as images of unsafe situations, images of damaged equipment, or video of unsafe behavior. The machine learning model can include various machine learning model architectures (e.g., networks, backbones, algorithms, etc.), including but not limited to language models, LLMs, attention-based neural networks, transformer-based neural networks, generative pretrained transformer (GPT) models, bidirectional encoder representations from transformers (BERT) models, encoder/decoder models, sequence to sequence models, autoencoder models, generative adversarial networks (GANs), convolutional neural networks (CNNs), recurrent neural networks (RNNs), diffusion models (e.g., denoising diffusion probabilistic models (DDPMs)), or various combinations thereof.

At least one aspect relates to a method. The method can include receiving, by one or more processor, a prompt identifying one or more characteristics of a training data image. The method can include generating, by the one or more processors using at least one generative artificial intelligence (AI) model, the training data image based on the one or more characteristics. The method can include providing, by the one or more processors, the training data image as input to at least one neural network to configure the at least one neural network using the training data image.

At least one aspect relates to a system. The system can include one or more processors and a non-transitory, computer-readable memory comprising instructions which, when executed by the one or more processors, cause the one or more processors to receive a prompt identifying one or more characteristics of a training data image. The one or more processors can generate, using at least one generative artificial intelligence (AI) model, the training data image based on the one or more characteristics. The one or more processors can provide the training data image as input to at least one neural network to configure the at least one neural network using the training data image.

At least one aspect relates to a method. The method can include receiving, by one or more processor, a prompt identifying one or more characteristics of a training data image. The method can include generating, by the one or more processors using at least one machine learning model, the training data image based on the one or more characteristics. The method can include providing, by the one or more processors, the training data image as input to the at least one machine learning model to configure the at least one machine learning model using the training data image.

At least one aspect relates to a system. The system can include one or more processors and a non-transitory, computer-readable memory comprising instructions which, when executed by the one or more processors, cause the one or more processors to receive a prompt identifying one or more characteristics of a training data image. The one or more processors can generate, using at least one machine learning model, the training data image based on the one or more characteristics. The one or more processors can provide the training data image as input to the at least one machine learning model to configure the at least one machine learning model using the training data image.

At least one aspect relates to a method. The method can include obtaining, by one or more processors, a background image of a building/work site. The method can include obtaining, by the one or more processors, a subject image depicting a subject event. The method can include generating, by the one or more processors using a generative artificial intelligence (AI) model, a blended image by combining the subject image with the background image, the blended image depicting the subject event occurring at the building/work site. The method can include providing, by the one or more processors, the blended image as training data input to at least one neural network to configure the at least one neural network using the blended image.

At least one aspect relates to a system. The system can include one or more processors and one or more non-transitory computer-readable media storing instructions that, when executed by the one or more processors, cause the one or more processors to perform operations. The operations can include obtaining a background image of a building/work site, obtaining a subject image depicting a subject event, and generating a blended image by combining the subject image with the background image using a generative artificial intelligence (AI) model. The blended image can depict the subject event occurring at the building/work site. The operations can include providing the blended image as training data input to at least one neural network to configure the at least one neural network using the blended image.

### BRIEF DESCRIPTION OF THE DRAWINGS

Various objects, aspects, features, and advantages of the disclosure will become more apparent and better understood by referring to the detailed description taken in conjunction with the accompanying drawings, in which like reference characters identify corresponding elements throughout. In the drawings, like reference numbers generally indicate identical, functionally similar, and/or structurally similar elements.

FIG. 1 is a block diagram of an example of a machine learning model-based system for equipment servicing applications.

FIG. 2 is a block diagram of an example of a language model-based system for equipment servicing applications.

FIG. 3 is a block diagram of an example of the system of FIG. 2 including user application session components.

FIG. 4 is a block diagram of an example of the system of FIG. 2 including feedback training components.

FIG. 5 is a block diagram of an example of the system of FIG. 2 including data filters.

FIG. 6 is a block diagram of an example of the system of FIG. 2 including data validation components.

FIG. 7 is a block diagram of an example of the system of FIG. 2 including expert review and intervention components.

FIG. 8 is a flow diagram of a method of managing equipment servicing responsive to fault detection using machine learning models.

FIG. 9 is a flow diagram of a method of detecting conditions using machine learning models.

FIG. 10 is a block diagram illustrating a portion of the system of FIG. 2 in greater detail with additional components for blending background site images with images depicting subject events.

FIG. 11 is a diagram illustrating the operation of the system of FIG. 10 to generate blended images depicting subject events at a specified site.

FIG. 12 is another diagram illustrating the operation of the system of FIG. 10 to generate blended images depicting subject events at a specified site.

FIG. 13 is a flowchart of a process which can be performed by the system of FIG. 10 to detect subject events at a specified site using AI models.

### DETAILED DESCRIPTION

Referring generally to the FIGURES, systems and methods in accordance with the present disclosure can implement various systems to precisely generate data relating to operations to be performed for detecting conditions and monitoring risks associated with building systems and components and/or items of equipment, including heating, ventilation, cooling, and/or refrigeration (HVAC-R) systems and components. For example, various systems described herein can be implemented to generate training data for a neural network which detects conditions associated with building management in images or video. The conditions can include, but are not limited to, conditions that satisfy one or more risk criteria.

In some systems, service operations can be supported by text information, such as predefined text documents such as service, diagnostic, and/or troubleshooting guides. Various such text information may not be useful for specific service requests and/or technicians performing the service. For example, the text information may correspond to different items of equipment or versions of items of equipment to be serviced. The text information, being predefined, may not account for specific technical issues that may be present in the items of equipment to be serviced.

AI and/or machine learning (ML) systems, including but not limited to LLMs, can be used to generate text data and data of other modalities in a more responsive manner to real-time conditions, including generating strings of text data that may not be provided in the same manner in existing documents, yet may still meet criteria for useful text information, such as relevance, style, and coherence. For example, LLMs can predict text data based at least on inputted prompts and by being configured (e.g., trained, modified, updated, fine-tuned) according to training data representative of the text data to predict or otherwise generate.

However, various considerations may limit the ability of such systems to precisely generate appropriate data for specific conditions. For example, due to the predictive nature of the generated data, some LLMs may generate text data that is incorrect, imprecise, or not relevant to the specific conditions. Using the LLMs may require a user to manually vary the content and/or syntax of inputs provided to the LLMs (e.g., vary inputted prompts) until the output of the LLMs meets various objective or subjective criteria of the user. The LLMs can have token limits for sizes of inputted text during training and/or runtime/inference operations (and relaxing or increasing such limits may require increased computational processing, API calls to LLM services, and/or memory usage), limiting the ability of the LLMs to be effectively configured or operated using large amounts of raw data or otherwise unstructured data.

Systems and methods in accordance with the present disclosure can use machine learning models, including LLMs and other generative AI systems, to capture data, including but not limited to unstructured knowledge from various data sources, and process the data to accurately generate outputs, such as completions responsive to prompts, including in structured data formats for various applications and use cases. The system can implement various automated and/or expert-based thresholds and data quality management processes to improve the accuracy and quality of generated outputs and update training of the machine learning models accordingly. The system can enable real-time messaging and/or conversational interfaces for users to provide field data regarding equipment to the system (including presenting targeted queries to users that are expected to elicit relevant responses for efficiently receiving useful response information from users) and guide users, such as service technicians, through relevant service, diagnostic, troubleshooting, and/or repair processes.

This can include, for example, receiving data from technician service reports in various formats, including various modalities and/or multi-modal formats (e.g., text, speech, audio, image, and/or video). The system can facilitate automated, flexible customer report generation, such as by processing information received from service technicians and other users into a standardized format, which can reduce the constraints on how the user submits data while improving resulting reports. The system can couple unstructured service data to other input/output data sources and analytics, such as to relate unstructured data with outputs of timeseries data from equipment (e.g., sensor data; report logs) and/or outputs from models or algorithms of equipment operation, which can facilitate more accurate analytics, prediction services, diagnostics, and/or fault detection. The system can perform classification or other pattern recognition or trend detection operations to facilitate more timely assignment of technicians, scheduling of technicians based on expected times for jobs, and provisioning of trucks, tools, and/or parts. The system can perform root cause prediction by being trained using data that includes indications of root causes of faults or errors, where the indications are labels for or otherwise associated with (unstructured or structure) data such as service requests, service reports, service calls, etc. The system can receive, from a service technician in the field evaluating the issue with the equipment, feedback regarding the accuracy of the root cause predictions, as well as feedback regarding how the service technician evaluated information about the equipment (e.g., what data did they evaluate; what did they inspect; did the root cause prediction or instructions for finding the root cause accurately match the type of equipment, etc.), which can be used to update the root cause prediction model.

For example, the system can provide a platform for fault detection and servicing processes in which a machine learning model is configured based on connecting or relating unstructured data and/or semantic data, such as human feedback and written/spoken reports, with time-series product data regarding items of equipment, so that the machine learning model can more accurately detect causes of alarms or other events that may trigger service responses. For instance, responsive to an alarm for a chiller, the system can more accurately detect a cause of the alarm, and generate a prescription (e.g., for a service technician) for responding to the alarm; the system can request feedback from the service technician regarding the prescription, such as whether the prescription correctly identified the cause of the alarm and/or actions to perform to respond to the cause, as well as the information that the service technician used to evaluate the correctness or accuracy of the prescription; the system can use this feedback to modify the machine learning models, which can increase the accuracy of the machine learning models.

In some instances, significant computational resources (or human user resources) can be required to process data relating to equipment operation, such as time-series product data and/or sensor data, to detect or predict faults and/or causes of faults. In addition, it can be resource-intensive to label such data with identifiers of faults or causes of faults, which can make it difficult to generate machine learning training data from such data. Systems and methods in accordance with the present disclosure can leverage the efficiency of language models (e.g., GPT-based models or other pre-trained LLMs) in extracting semantic information (e.g., semantic information identifying faults, causes of faults, and other accurate expert knowledge regarding equipment servicing) from the unstructured data in order to use both the unstructured data and the data relating to equipment operation to generate more accurate outputs regarding equipment servicing. As such, by implementing language models using various operations and processes described herein, building management and equipment servicing systems can take advantage of the causal/semantic associations between the unstructured data and the data relating to equipment operation, and the language models can allow these systems to more efficiently extract these relationships in order to more accurately predict targeted, useful information for servicing applications at inference-time/runtime. While various implementations are described as being implemented using generative AI models such as transformers and/or GANs, in some embodiments, various features described herein can be implemented using non-generative AI models or even without using AI/machine learning, and all such modifications fall within the scope of the present disclosure.

The system can enable a generative AI-based service wizard interface. For example, the interface can include user interface and/or user experience features configured to provide a question/answer-based input/output format, such as a conversational interface, that directs users through providing targeted information for accurately generating predictions of root cause, presenting solutions, or presenting instructions for repairing or inspecting the equipment to identify information that the system can use to detect root causes or other issues. The system can use the interface to present information regarding parts and/or tools to service the equipment, as well as instructions for how to use the parts and/or tools to service the equipment.

In various implementations, the systems can include a plurality of machine learning models that may be configured using integrated or disparate data sources. This can facilitate more integrated user experiences or more specialized (and/or lower computational usage for) data processing and output generation. Outputs from one or more first systems, such as one or more first algorithms or machine learning models, can be provided at least as part of inputs to one or more second systems, such as one or more second algorithms or machine learning models. For example, a first language model can be configured to process unstructured inputs (e.g., text, speech, images, etc.) into a structure output format compatible for use by a second system, such as a root cause prediction algorithm or equipment configuration model.

The system can be used to automate interventions for equipment operation, servicing, fault detection and diagnostics (FDD), and alerting operations. For example, by being configured to perform operations such as root cause prediction, the system can monitor data regarding equipment to predict events associated with faults and trigger responses such as alerts, service scheduling, and initiating FDD or modifications to configuration of the equipment. The system can present to a technician or manager of the equipment a report regarding the intervention (e.g., action taken responsive to predicting a fault or root cause condition) and requesting feedback regarding the accuracy of the intervention, which can be used to update the machine learning models to more accurately generate interventions.

In some embodiments, the systems and methods described herein may include any of the features and/or functionality described in U.S. patent application Ser. No. 18/663,793 filed May 14, 2024, the entire disclosure of which is incorporated by reference herein.

### I. Machine Learning Models for Building Management and Equipment Servicing

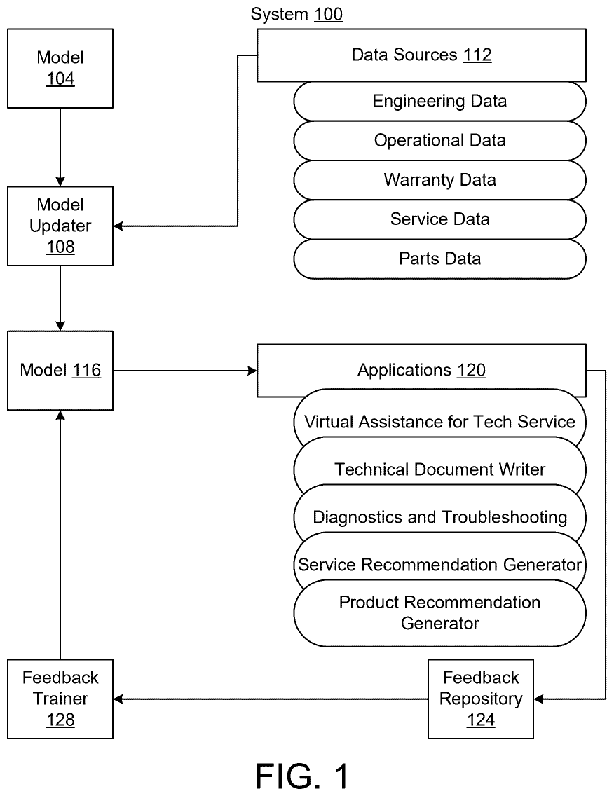

FIG. 1 depicts an example of a system 100. The system 100 can implement various operations for configuring (e.g., training, updating, modifying, transfer learning, fine-tuning, etc.) and/or operating various AI and/or ML systems, such as neural networks of LLMs or other generative AI systems. The system 100 can be used to implement various generative AI-based building equipment servicing operations.

For example, the system 100 can be implemented for operations associated with any of a variety of building management systems (BMSs) or equipment or components thereof. A BMS can include a system of devices that can control, monitor, and manage equipment in or around a building or building area. The BMS can include, for example, a HVAC system, a security system, a lighting system, a fire alerting system, any other system that is capable of managing building functions or devices, or any combination thereof. The BMS can include or be coupled with items of equipment, for example and without limitation, such as heaters, chillers, boilers, air handling units, sensors, actuators, refrigeration systems, fans, blowers, heat exchangers, energy storage devices, condensers, valves, or various combinations thereof.

The items of equipment can operate in accordance with various qualitative and quantitative parameters, variables, setpoints, and/or thresholds or other criteria, for example. In some instances, the system 100 and/or the items of equipment can include or be coupled with one or more controllers for controlling parameters of the items of equipment, such as to receive control commands for controlling operation of the items of equipment via one or more wired, wireless, and/or user interfaces of controller.

Various components of the system 100 or portions thereof can be implemented by one or more processors coupled with or more memory devices (memory). The processors can be a general purpose or specific purpose processors, an application specific integrated circuit (ASIC), one or more field programmable gate arrays (FPGAs), a group of processing components, or other suitable processing components. The processors may be configured to execute computer code and/or instructions stored in the memories or received from other computer readable media (e.g., CDROM, network storage, a remote server, etc.). The processors can be configured in various computer architectures, such as graphics processing units (GPUs), distributed computing architectures, cloud server architectures, client-server architectures, or various combinations thereof. One or more first processors can be implemented by a first device, such as an edge device, and one or more second processors can be implemented by a second device, such as a server or other device that is communicatively coupled with the first device and may have greater processor and/or memory resources.

The memories can include one or more devices (e.g., memory units, memory devices, storage devices, etc.) for storing data and/or computer code for completing and/or facilitating the various processes described in the present disclosure. The memories can include random access memory (RAM), read-only memory (ROM), hard drive storage, temporary storage, non-volatile memory, flash memory, optical memory, or any other suitable memory for storing software objects and/or computer instructions. The memories can include database components, object code components, script components, or any other type of information structure for supporting the various activities and information structures described in the present disclosure. The memories can be communicably connected to the processors and can include computer code for executing (e.g., by the processors) one or more processes described herein.

### Machine Learning Models

The system 100 can include or be coupled with one or more first models 104. The first model 104 can include one or more neural networks, including neural networks configured as generative models. For example, the first model 104 can predict or generate new data (e.g., artificial data; synthetic data; data not explicitly represented in data used for configuring the first model 104). The first model 104 can generate any of a variety of modalities of data, such as text, speech, audio, images, and/or video data. The neural network can include a plurality of nodes, which may be arranged in layers for providing outputs of one or more nodes of one layer as inputs to one or more nodes of another layer. The neural network can include one or more input layers, one or more hidden layers, and one or more output layers. Each node can include or be associated with parameters such as weights, biases, and/or thresholds, representing how the node can perform computations to process inputs to generate outputs. The parameters of the nodes can be configured by various learning or training operations, such as unsupervised learning, weakly supervised learning, semi-supervised learning, or supervised learning.

The first model 104 can include, for example and without limitation, one or more language models, LLMs, attention-based neural networks, transformer-based neural networks, generative pretrained transformer (GPT) models, bidirectional encoder representations from transformers (BERT) models, encoder/decoder models, sequence to sequence models, autoencoder models, generative adversarial networks (GANs), convolutional neural networks (CNNs), recurrent neural networks (RNNs), diffusion models (e.g., denoising diffusion probabilistic models (DDPMs)), or various combinations thereof.

For example, the first model 104 can include at least one GPT model. The GPT model can receive an input sequence, and can parse the input sequence to determine a sequence of tokens (e.g., words or other semantic units of the input sequence, such as by using Byte Pair Encoding tokenization). The GPT model can include or be coupled with a vocabulary of tokens, which can be represented as a one-hot encoding vector, where each token of the vocabulary has a corresponding index in the encoding vector; as such, the GPT model can convert the input sequence into a modified input sequence, such as by applying an embedding matrix to the token tokens of the input sequence (e.g., using a neural network embedding function), and/or applying positional encoding (e.g., sin-cosine positional encoding) to the tokens of the input sequence. The GPT model can process the modified input sequence to determine a next token in the sequence (e.g., to append to the end of the sequence), such as by determining probability scores indicating the likelihood of one or more candidate tokens being the next token, and selecting the next token according to the probability scores (e.g., selecting the candidate token having the highest probability scores as the next token). For example, the GPT model can apply various attention and/or transformer based operations or networks to the modified input sequence to identify relationships between tokens for detecting the next token to form the output sequence.

The first model 104 can include at least one diffusion model, which can be used to generate image and/or video data. For example, the diffusional model can include a denoising neural network and/or a denoising diffusion probabilistic model neural network. The denoising neural network can be configured by applying noise to one or more training data elements (e.g., images, video frames) to generate noised data, providing the noised data as input to a candidate denoising neural network, causing the candidate denoising neural network to modify the noised data according to a denoising schedule, evaluating a convergence condition based on comparing the modified noised data with the training data instances, and modifying the candidate denoising neural network according to the convergence condition (e.g., modifying weights and/or biases of one or more layers of the neural network). In some implementations, the first model 104 includes a plurality of generative models, such as GPT and diffusion models, that can be trained separately or jointly to facilitate generating multi-modal outputs, such as technical documents (e.g., service guides) that include both text and image/video information.

In some implementations, the first model 104 can be configured using various unsupervised and/or supervised training operations. The first model 104 can be configured using training data from various domain-agnostic and/or domain-specific data sources, including but not limited to various forms of text, speech, audio, image, and/or video data, or various combinations thereof. The training data can include a plurality of training data elements (e.g., training data instances). Each training data element can be arranged in structured or unstructured formats; for example, the training data element can include an example output mapped to an example input, such as a query representing a service request or one or more portions of a service request, and a response representing data provided responsive to the query. The training data can include data that is not separated into input and output subsets (e.g., for configuring the first model 104 to perform clustering, classification, or other unsupervised ML operations). The training data can include human-labeled information, including but not limited to feedback regarding outputs of the models 104, 116. This can allow the system 100 to generate more human-like outputs.

In some implementations, the training data includes data relating to building management systems. For example, the training data can include examples of HVAC-R data, such as operating manuals, technical data sheets, configuration settings, operating setpoints, diagnostic guides, troubleshooting guides, user reports, technician reports. In some implementations, the training data used to configure the first model 104 includes at least some publicly accessible data, such as data retrievable via the Internet.

Referring further to FIG. 1, the system 100 can configure the first model 104 to determine one or more second models 116. For example, the system 100 can include a model updater 108 that configures (e.g., trains, updates, modifies, fine-tunes, etc.) the first model 104 to determine the one or more second models 116. In some implementations, the second model 116 can be used to provide application-specific outputs, such as outputs having greater precision, accuracy, or other metrics, relative to the first model, for targeted applications.

The second model 116 can be similar to the first model 104. For example, the second model 116 can have a similar or identical backbone or neural network architecture as the first model 104. In some implementations, the first model 104 and the second model 116 each include generative AI machine learning models, such as LLMs (e.g., GPT-based LLMs) and/or diffusion models. The second model 116 can be configured using processes analogous to those described for configuring the first model 104.

In some implementations, the model updater 108 can perform operations on at least one of the first model 104 or the second model 116 via one or more interfaces, such as application programming interfaces (APIs). For example, the models 104, 116 can be operated and maintained by one or more systems separate from the system 100. The model updater 108 can provide training data to the first model 104, via the API, to determine the second model 116 based on the first model 104 and the training data. The model updater 108 can control various training parameters or hyperparameters (e.g., learning rates, etc.) by providing instructions via the API to manage configuring the second model 116 using the first model 104.

### Data Sources

The model updater 108 can determine the second model 116 using data from one or more data sources 112. For example, the system 100 can determine the second model 116 by modifying the first model 104 using data from the one or more data sources 112. The data sources 112 can include or be coupled with any of a variety of integrated or disparate databases, data warehouses, digital twin data structures (e.g., digital twins of items of equipment or building management systems or portions thereof), data lakes, data repositories, documentation records, or various combinations thereof. In some implementations, the data sources 112 include HVAC-R data in any of text, speech, audio, image, or video data, or various combinations thereof, such as data associated with HVAC-R components and procedures including but not limited to installation, operation, configuration, repair, servicing, diagnostics, and/or troubleshooting of HVAC-R components and systems. Various data described below with reference to data sources 112 may be provided in the same or different data elements, and may be updated at various points. The data sources 112 can include or be coupled with items of equipment (e.g., where the items of equipment output data for the data sources 112, such as sensor data, etc.). The data sources 112 can include various online and/or social media sources, such as blog posts or data submitted to applications maintained by entities that manage the buildings. The system 100 can determine relations between data from different sources, such as by using timeseries information and identifiers of the sites or buildings at which items of equipment are present to detect relationships between various different data relating to the items of equipment (e.g., to train the models 104, 116 using both timeseries data (e.g., sensor data; outputs of algorithms or models, etc.) regarding a given item of equipment and freeform natural language reports regarding the given item of equipment).

The data sources 112 can include unstructured data or structured data (e.g., data that is labeled with or assigned to one or more predetermined fields or identifiers). For example, using the first model 104 and/or second model 116 to process the data can allow the system 100 to extract useful information from data in a variety of formats, including unstructured/freeform formats, which can allow service technicians to input information in less burdensome formats. The data can be of any of a plurality of formats (e.g., text, speech, audio, image, video, etc.), including multi-modal formats. For example, the data may be received from service technicians in forms such as text (e.g., laptop/desktop or mobile application text entry), audio, and/or video (e.g., dictating findings while capturing video).

The data sources 112 can include engineering data regarding one or more items of equipment. The engineering data can include manuals, such as installation manuals, instruction manuals, or operating procedure guides. The engineering data can include specifications or other information regarding operation of items of equipment. The engineering data can include engineering drawings, process flow diagrams, refrigeration cycle parameters (e.g., temperatures, pressures), or various other information relating to structures and functions of items of equipment.

In some implementations, the data sources 112 can include operational data regarding one or more items of equipment. The operational data can represent detected information regarding items of equipment, such as sensor data, logged data, user reports, or technician reports. The operational data can include, for example, service tickets generated responsive to requests for service, work orders, data from digital twin data structures maintained by an entity of the item of equipment, outputs or other information from equipment operation models (e.g., chiller vibration models), or various combinations thereof. Logged data, user reports, service tickets, billing records, time sheets, and various other such data can provide temporal information, such as how long service operations may take, or durations of time between service operations, which can allow the system 100 to predict resources to use for performing service as well as when to request service.

The data sources 112 can include, for instance, warranty data. The warranty data can include warranty documents or agreements that indicate conditions under which various entities associated with items of equipment are to provide service, repair, or other actions corresponding to items of equipment, such as actions corresponding to service requests.

The data sources 112 can include service data. The service data can include data from any of various service providers, such as service reports. The service data can indicate service procedures performed, including associated service procedures with initial service requests and/or sensor data related conditions to trigger service and/or sensor data measured during service processes.

In some implementations, the data sources 112 can include parts data, including but not limited to parts usage and sales data. For example, the data sources 112 can indicate various parts associated with installation or repair of items of equipment. The data sources 112 can indicate tools for performing service and/or installing parts.

The system 100 can include, with the data of the data sources 112, labels to facilitate cross-reference between items of data that may relate to common items of equipment, sites, service technicians, customers, or various combinations thereof. For example, data from disparate sources may be labeled with time data, which can allow the system 100 (e.g., by configuring the models 104, 116) to increase a likelihood of associating information from the disparate sources due to the information being detected or recorded (e.g., as service reports) at the same time or near in time.

For example, the data sources 112 can include data that can be particular to specific or similar items of equipment, buildings, equipment configurations, environmental states, or various combinations thereof. In some implementations, the data includes labels or identifiers of such information, such as to indicate locations, weather conditions, timing information, uses of the items of equipment or the buildings or sites at which the items of equipment are present, etc. This can enable the models 104, 116 to detect patterns of usage (e.g., spikes; troughs; seasonal or other temporal patterns) or other information that may be useful for determining causes of issues or causes of service requests, or predict future issues, such as to allow the models 104, 116 to be trained using information indicative of causes of issues across multiple items of equipment (which may have the same or similar causes even if the data regarding the items of equipment is not identical). For example, an item of equipment may be at a site that is a museum; by relating site usage or occupancy data with data regarding the item of equipment, such as sensor data and service reports, the system 100 can configure the models 104, 116 to determine a high likelihood of issues occurring before events associated with high usage (e.g., gala, major exhibit opening), and can generate recommendations to perform diagnostics or servicing prior to the events.

### Model Configuration

Referring further to FIG. 1, the model updater 108 can perform various machine learning model configuration/training operations to determine the second models 116 using the data from the data sources 112. For example, the model updater 108 can perform various updating, optimization, retraining, reconfiguration, fine-tuning, or transfer learning operations, or various combinations thereof, to determine the second models 116. The model updater 108 can configure the second models 116, using the data sources 112, to generate outputs (e.g., completions) in response to receiving inputs (e.g., prompts), where the inputs and outputs can be analogous to data of the data sources 112.

For example, the model updater 108 can identify one or more parameters (e.g., weights and/or biases) of one or more layers of the first model 104, and maintain (e.g., freeze, maintain as the identified values while updating) the values of the one or more parameters of the one or more layers. In some implementations, the model updater 108 can modify the one or more layers, such as to add, remove, or change an output layer of the one or more layers, or to not maintain the values of the one or more parameters. The model updater 108 can select at least a subset of the identified one or parameters to maintain according to various criteria, such as user input or other instructions indicative of an extent to which the first model 104 is to be modified to determine the second model 116. In some implementations, the model updater 108 can modify the first model 104 so that an output layer of the first model 104 corresponds to output to be determined for applications 120.

Responsive to selecting the one or more parameters to maintain, the model updater 108 can apply, as input to the second model 116 (e.g., to a candidate second model 116, such as the modified first model 104, such as the first model 104 having the identified parameters maintained as the identified values), training data from the data sources 112. For example, the model updater 108 can apply the training data as input to the second model 116 to cause the second model 116 to generate one or more candidate outputs.

The model updater 108 can evaluate a convergence condition to modify the candidate second model 116 based at least on the one or more candidate outputs and the training data applied as input to the candidate second model 116. For example, the model updater 108 can evaluate an objective function of the convergence condition, such as a loss function (e.g., L1 loss, L2 loss, root mean square error, cross-entropy or log loss, etc.) based on the one or more candidate outputs and the training data; this evaluation can indicate how closely the candidate outputs generated by the candidate second model 116 correspond to the ground truth represented by the training data. The model updater 108 can use any of a variety of optimization algorithms (e.g., gradient descent, stochastic descent, Adam optimization, etc.) to modify one or more parameters (e.g., weights or biases of the layer(s) of the candidate second model 116 that are not frozen) of the candidate second model 116 according to the evaluation of the objective function. In some implementations, the model updater 108 can use various hyperparameters to evaluate the convergence condition and/or perform the configuration of the candidate second model 116 to determine the second model 116, including but not limited to hyperparameters such as learning rates, numbers of iterations or epochs of training, etc.

As described further herein with respect to applications 120, in some implementations, the model updater 108 can select the training data from the data of the data sources 112 to apply as the input based at least on a particular application of the plurality of applications 120 for which the second model 116 is to be used for. For example, the model updater 108 can select data from the parts data source 112 for the product recommendation generator application 120, or select various combinations of data from the data sources 112 (e.g., engineering data, operational data, and service data) for the service recommendation generator application 120. The model updater 108 can apply various combinations of data from various data sources 112 to facilitate configuring the second model 116 for one or more applications 120.

In some implementations, the system 100 can perform at least one of conditioning, classifier-based guidance, or classifier-free guidance to configure the second model 116 using the data from the data sources 112. For example, the system 100 can use classifiers associated with the data, such as identifiers of the item of equipment, a type of the item of equipment, a type of entity operating the item of equipment, a site at which the item of equipment is provided, or a history of issues at the site, to condition the training of the second model 116. For example, the system 100 combine (e.g., concatenate) various such classifiers with the data for inputting to the second model 116 during training, for at least a subset of the data used to configure the second model 116, which can enable the second model 116 to be responsive to analogous information for runtime/inference time operations.

### Applications

Referring further to FIG. 1, the system 100 can use outputs of the one or more second models 116 to implement one or more applications 120. For example, the second models 116, having been configured using data from the data sources 112, can be capable of precisely generating outputs that represent useful, timely, and/or real-time information for the applications 120. In some implementations, each application 120 is coupled with a corresponding second model 116 that is specifically configured to generate outputs for use by the application 120. Various applications 120 can be coupled with one another, such as to provide outputs from a first application 120 as inputs or portions of inputs to a second application 120.

The applications 120 can include any of a variety of desktop, web-based/browser-based, or mobile applications. For example, the applications 120 can be implemented by enterprise management software systems, employee or other user applications (e.g., applications that relate to BMS functionality such as temperature control, user preferences, conference room scheduling, etc.), equipment portals that provide data regarding items of equipment, or various combinations thereof. The applications 120 can include user interfaces, wizards, checklists, conversational interfaces, chatbots, configuration tools, or various combinations thereof. The applications 120 can receive an input, such as a prompt (e.g., from a user), provide the prompt to the second model 116 to cause the second model 116 to generate an output, such as a completion in response to the prompt, and present an indication of the output. The applications 120 can receive inputs and/or present outputs in any of a variety of presentation modalities, such as text, speech, audio, image, and/or video modalities. For example, the applications 120 can receive unstructured or freeform inputs from a user, such as a service technician, and generate reports in a standardized format, such as a customer-specific format. This can allow, for example, technicians to automatically, and flexibly, generate customer-ready reports after service visits without requiring strict input by the technician or manually sitting down and writing reports; to receive inputs as dictations in order to generate reports; to receive inputs in any form or a variety of forms, and use the second model 116 (which can be trained to cross-reference metadata in different portions of inputs and relate together data elements) to generate output reports (e.g., the second model 116, having been configured with data that includes time information, can use timestamps of input from dictation and timestamps of when an image is taken, and place the image in the report in a target position or label based on time correlation).

In some implementations, the applications 120 include at least one virtual assistant (e.g., virtual assistance for technician services) application 120. The virtual assistant application can provide various services to support technician operations, such as presenting information from service requests, receiving queries regarding actions to perform to service items of equipment, and presenting responses indicating actions to perform to service items of equipment. The virtual assistant application can receive information regarding an item of equipment to be serviced, such as sensor data, text descriptions, or camera images, and process the received information using the second model 116 to generate corresponding responses.

For example, the virtual assistant application 120 can be implemented in a UI/UX wizard configuration, such as to provide a sequence of requests for information from the user (the sequence may include requests that are at least one of predetermined or dynamically generated responsive to inputs from the user for previous requests). For example, the virtual assistant application 120 can provide one or more requests for users such as service technicians, facility managers, or other occupants, and provide the received responses to at least one of the second model 116 or a root cause detection function (e.g., algorithm, model, data structure mapping inputs to candidate causes, etc.) to determine a prediction of a cause of the issue of the item of equipment and/or solutions. The virtual assistant application 120 can use requests for information such as for unstructured text by which the user describes characteristics of the item of equipment relating to the issue; answers expected to correspond to different scenarios indicative of the issue; and/or image and/or video input (e.g., images of problems, equipment, spaces, etc. that can provide more context around the issue and/or configurations). For example, responsive to receiving a response via the virtual assistant application 120 indicating that the problem is with temperature in the space, the system 100 can request, via the virtual assistant application 120, information regarding HVAC-R equipment associated with the space, such as pictures of the space, an air handling unit, a chiller, or various combinations thereof.

The virtual assistant application 120 can include a plurality of applications 120 (e.g., variations of interfaces or customizations of interfaces) for a plurality of respective user types. For example, the virtual assistant application 120 can include a first application 120 for a customer user, and a second application 120 for a service technician user. The virtual assistant applications 120 can allow for updating and other communications between the first and second applications 120 as well as the second model 116. Using one or more of the first application 120 and the second application 120, the system 100 can manage continuous/real-time conversations for one or more users, and evaluate the users' engagement with the information provided (e.g., did the user, customer, service technician, etc., follow the provided steps for responding to the issue or performing service, did the user discontinue providing inputs to the virtual assistant application 120, etc.), such as to enable the system 100 to update the information generated by the second model 116 for the virtual assistant application 120 according to the engagement. In some implementations, the system 100 can use the second model 116 to detect sentiment of the user of the virtual assistant application 120, and update the second model 116 according to the detected sentiment, such as to improve the experience provided by the virtual assistant application 120.

The applications 120 can include at least one document writer application 120, such as a technical document writer. The document writer application 120 can facilitate preparing structured (e.g. form-based) and/or unstructured documentation, such as documentation associated with service requests. For example, the document writer application 120 can present a user interface corresponding to a template document to be prepared that is associated with at least one of a service request or the item of equipment for which the service request is generated, such as to present one or more predefined form sections or fields. The document writer application 120 can use inputs, such as prompts received from the users and/or technical data provided by the user regarding the item of equipment, such as sensor data, text descriptions, or camera images, to generate information to include in the documentation. For example, the document writer application 120 can provide the inputs to the second model 116 to cause the second model 116 to generate completions for text information to include in the fields of the documentation.

The applications 120 can include, in some implementations, at least one diagnostics and troubleshooting application 120. The diagnostics and troubleshooting application 120 can receive inputs including at least one of a service request or information regarding the item of equipment to be serviced, such as information identified by a service technician. The diagnostics and troubleshooting application 120 can provide the inputs to a corresponding second model 116 to cause the second model 116 to generate outputs such as indications of potential items to be checked regarding the item of equipment, modifications or fixes to make to perform the service, or values or ranges of values of parameters of the item of equipment that may be indicative of specific issues to for the service technician to address or repair.

The applications 120 can at least one service recommendation generator application 120. The service recommendation generator application 120 can receive inputs such as a service request or information regarding the item of equipment to be serviced, and provide the inputs to the second model 116 to cause the second model 116 to generate outputs for presenting service recommendations, such as actions to perform to address the service request.

In some implementations, the applications 120 can include a product recommendation generator application 120. The product recommendation generator application 120 can process inputs such as information regarding the item of equipment or the service request, using one or more second models 116 (e.g., models trained using parts data from the data sources 112), to determine a recommendation of a part or product to replace or otherwise use for repairing the item of equipment.

### Feedback Training

Referring further to FIG. 1, the system 100 can include at least one feedback trainer 128 coupled with at least one feedback repository 124. The system 100 can use the feedback trainer 128 to increase the precision and/or accuracy of the outputs generated by the second models 116 according to feedback provided by users of the system 100 and/or the applications 120.

The feedback repository 124 can include feedback received from users regarding output presented by the applications 120. For example, for at least a subset of outputs presented by the applications 120, the applications 120 can present one or more user input elements for receiving feedback regarding the outputs. The user input elements can include, for example, indications of binary feedback regarding the outputs (e.g., good/bad feedback; feedback indicating the outputs do or do not meet the user's criteria, such as criteria regarding technical accuracy or precision); indications of multiple levels of feedback (e.g., scoring the outputs on a predetermined scale, such as a 1-5 scale or 1-10 scale); freeform feedback (e.g., text or audio feedback); or various combinations thereof.

The system 100 can store and/or maintain feedback in the feedback repository 124. In some implementations, the system 100 stores the feedback with one or more data elements associated with the feedback, including but not limited to the outputs for which the feedback was received, the second model(s) 116 used to generate the outputs, and/or input information used by the second models 116 to generate the outputs (e.g., service request information; information captured by the user regarding the item of equipment).

The feedback trainer 128 can update the one or more second models 116 using the feedback. The feedback trainer 128 can be similar to the model updater 108. In some implementations, the feedback trainer 128 is implemented by the model updater 108; for example, the model updater 108 can include or be coupled with the feedback trainer 128. The feedback trainer 128 can perform various configuration operations (e.g., retraining, fine-tuning, transfer learning, etc.) on the second models 116 using the feedback from the feedback repository 124. In some implementations, the feedback trainer 128 identifies one or more first parameters of the second model 116 to maintain as having predetermined values (e.g., freeze the weights and/or biases of one or more first layers of the second model 116), and performs a training process, such as a fine tuning process, to configure parameters of one or more second parameters of the second model 116 using the feedback (e.g., one or more second layers of the second model 116, such as output layers or output heads of the second model 116).

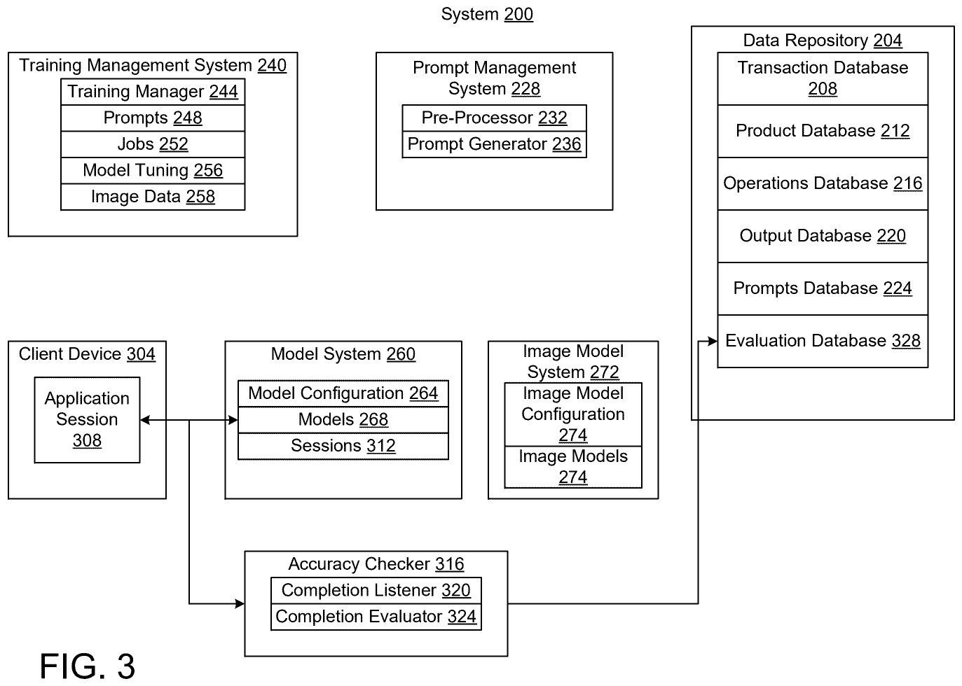

In some implementations, the system 100 may not include and/or use the model updater 108 (or the feedback trainer 128) to determine the second models 116. For example, the system 100 can include or be coupled with an output processor (e.g., an output processor similar or identical to accuracy checker 316 described with reference to FIG. 3) that can evaluate and/or modify outputs from the first model 104 prior to operation of applications 120, including to perform any of various post-processing operations on the output from the first model 104. For example, the output processor can compare outputs of the first model 104 with data from data sources 112 to validate the outputs of the first model 104 and/or modify the outputs of the first model 104 (or output an error) responsive to the outputs not satisfying a validation condition.

### Connected Machine Learning Models

Referring further to FIG. 1, the second model 116 can be coupled with one or more third models, functions, or algorithms for training/configuration and/or runtime operations. The third models can include, for example and without limitation, any of various models relating to items of equipment, such as energy usage models, sustainability models, carbon models, air quality models, or occupant comfort models. For example, the second model 116 can be used to process unstructured information regarding items of equipment into predefined template formats compatible with various third models, such that outputs of the second model 116 can be provided as inputs to the third models; this can allow more accurate training of the third models, more training data to be generated for the third models, and/or more data available for use by the third models. The second model 116 can receive inputs from one or more third models, which can provide greater data to the second model 116 for processing.

### Automated Service Scheduling and Provisioning

The system 100 can be used to automate operations for scheduling, provisioning, and deploying service technicians and resources for service technicians to perform service operations. For example, the system 100 can use at least one of the first model 104 or the second model 116 to determine, based on processing information regarding service operations for items of equipment relative to completion criteria for the service operation, particular characteristics of service operations such as experience parameters of scheduled service technicians, identifiers of parts provided for the service operations, geographical data, types of customers, types of problems, or information content provided to the service technicians to facilitate the service operation, where such characteristics correspond to the completion criteria being satisfied (e.g., where such characteristics correspond to an increase in likelihood of the completion criteria being satisfied relative to other characteristics for service technicians, parts, information content, etc.). For example, the system 100 can determine, for a given item of equipment, particular parts to include on a truck to be sent to the site of the item of equipment. As such, the system 100, responsive to processing inputs at runtime such as service requests, can automatically and more accurately identify service technicians and parts to direct to the item of equipment for the service operations. The system 100 can use timing information to perform batch scheduling for multiple service operations and/or multiple technicians for the same or multiple service operations. The system 100 can perform batch scheduling for multiple trucks for multiple items of equipment, such as to schedule a first one or more parts having a greater likelihood for satisfying the completion criteria for a first item of equipment on a first truck, and a second one or more parts having a greater likelihood for satisfying the completion criteria for a second item of equipment on a second truck.

### II. System Architectures for Generative AI Applications for Building Management System and Equipment Servicing

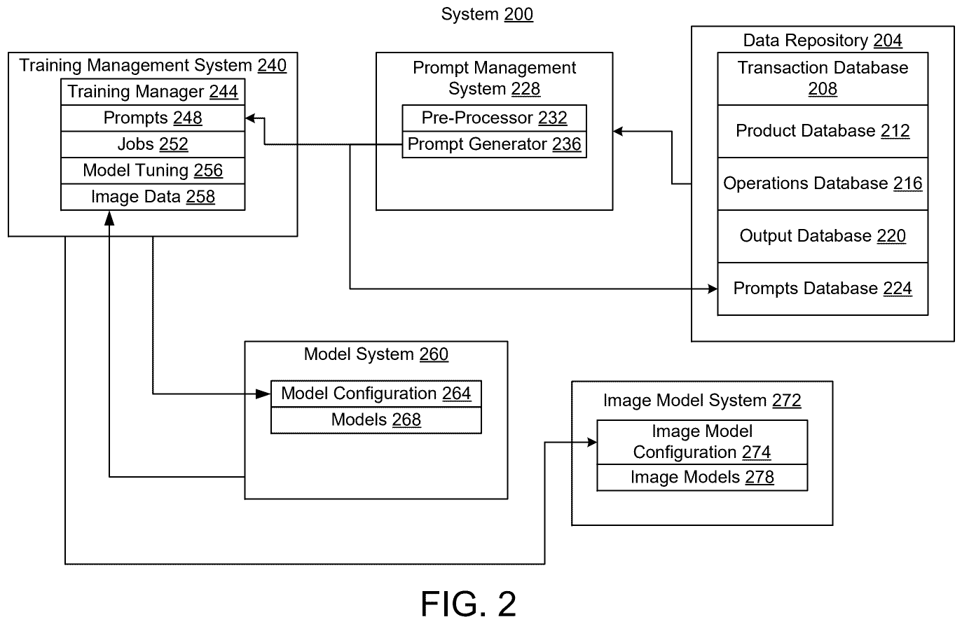

FIG. 2 depicts an example of a system 200. The system 200 can include one or more components or features of the system 100, such as any one or more of the first model 104, data sources 112, second model 116, applications 120, feedback repository 124, and/or feedback trainer 128. The system 200 can perform specific operations to enable generative AI applications for building managements systems and equipment servicing, such as various manners of processing input data into training data (e.g., tokenizing input data; forming input data into prompts and/or completions), and managing training and other machine learning model configuration processes. Various components of the system 200 can be implemented using one or more computer systems, which may be provided on the same or different processors (e.g., processors communicatively coupled via wired and/or wireless connections).

The system 200 can include at least one data repository 204, which can be similar to the data sources 112 described with reference to FIG. 1. For example, the data repository 204 can include a transaction database 208, which can be similar or identical to one or more of warranty data or service data of data sources 112. For example, the transaction database 208 can include data such as parts used for service transactions; sales data indicating various service transactions or other transactions regarding items of equipment; warranty and/or claims data regarding items of equipment; and service data.

The data repository 204 can include a product database 212, which can be similar or identical to the parts data of the data sources 112. The product database 212 can include, for example, data regarding products available from various vendors, specifications or parameters regarding products, and indications of products used for various service operations. The products database 212 can include data such as events or alarms associated with products; logs of product operation; and/or time series data regarding product operation, such as longitudinal data values of operation of products and/or building equipment.

The data repository 204 can include an operations database 216, which can be similar or identical to the operations data of the data sources 112. For example, the operations database 216 can include data such as manuals regarding parts, products, and/or items of equipment; customer service data; and or reports, such as operation or service logs.

In some implementations, the data repository 204 can include an output database 220, which can include data of outputs that may be generated by various machine learning models and/or algorithms. For example, the output database 220 can include values of pre-calculated predictions and/or insights, such as parameters regarding operation items of equipment, such as setpoints, changes in setpoints, flow rates, control schemes, identifications of error conditions, or various combinations thereof.

As depicted in FIG. 2, the system 200 can include a prompt management system 228. The prompt management system 228 can include one or more rules, heuristics, logic, policies, algorithms, functions, machine learning models, neural networks, scripts, or various combinations thereof to perform operations including processing data from data repository 204 into training data for configuring various machine learning models. For example, the prompt management system 228 can retrieve and/or receive data from the data repository 204, and determine training data elements that include examples of input and outputs for generation by machine learning models, such as a training data element that includes a prompt and a completion corresponding to the prompt, based on the data from the data repository 204.

In some implementations, the prompt management system 228 includes a pre-processor 232. The pre-processor 232 can perform various operations to prepare the data from the data repository 204 for prompt generation. For example, the pre-processor 232 can perform any of various filtering, compression, tokenizing, or combining (e.g., combining data from various databases of the data repository 204) operations.

The prompt management system 228 can include a prompt generator 236. The prompt generator 236 can generate, from data of the data repository 204, one or more training data elements that include a prompt and a completion corresponding to the prompt. In some implementations, the prompt generator 236 receives user input indicative of prompt and completion portions of data. For example, the user input can indicate template portions representing prompts of structured data, such as predefined fields or forms of documents, and corresponding completions provided for the documents. The user input can assign prompts to unstructured data. In some implementations, the prompt generator 236 automatically determines prompts and completions from data of the data repository 204, such as by using any of various natural language processing algorithms to detect prompts and completions from data. In some implementations, the system 200 does not identify distinct prompts and completions from data of the data repository 204.

Referring further to FIG. 2, the system 200 can include a training management system 240. The training management system 240 can include one or more rules, heuristics, logic, policies, algorithms, functions, machine learning models, neural networks, scripts, or various combinations thereof to perform operations including controlling training of machine learning models, including performing fine tuning and/or transfer learning operations.

The training management system 240 can include a training manager 244. The training manager 244 can incorporate features of at least one of the model updater 108 or the feedback trainer 128 described with reference to FIG. 1. For example, the training manager 244 can provide training data including a plurality of training data elements (e.g., prompts and corresponding completions) to the model system 260 as described further herein to facilitate training machine learning models.

In some implementations, the training management system 240 includes a prompts database 248. For example, the training management system 240 can store one or more training data elements from the prompt management system 228, such as to facilitate asynchronous and/or batched training processes.

The training manager 244 can control the training of machine learning models using information or instructions maintained in a model tuning database 256. For example, the training manager 244 can store, in the model tuning database 256, various parameters or hyperparameters for models and/or model training.

In some implementations, the training manager 244 stores a record of training operations in a jobs database 252. For example, the training manager 244 can maintain data such as a queue of training jobs, parameters or hyperparameters to be used for training jobs, or information regarding performance of training.

Referring further to FIG. 2, the system 200 can include at least one model system 260 (e.g., one or more language model systems). The model system 260 can include one or more rules, heuristics, logic, policies, algorithms, functions, machine learning models, neural networks, scripts, or various combinations thereof to perform operations including configuring one or more machine learning models 268 based on instructions from the training management system 240. In some implementations, the training management system 240 implements the model system 260. In some implementations, the training management system 240 can access the model system 260 using one or more APIs, such as to provide training data and/or instructions for configuring machine learning models 268 via the one or more APIs. The model system 260 can operate as a service layer for configuring the machine learning models 268 responsive to instructions from the training management system 240. The machine learning models 268 can be or include the first model 104 and/or second model 116 described with reference to FIG. 1.

The model system 260 can include a model configuration processor 264. The model configuration processor 264 can incorporate features of the model updater 108 and/or the feedback trainer 128 described with reference to FIG. 1. For example, the model configuration processor 264 can apply training data (e.g., prompts 248 and corresponding completions) to the machine learning models 268 to configure (e.g., train, modify, update, fine-tune, etc.) the machine learning models 268. The training manager 244 can control training by the model configuration processor 264 based on model tuning parameters in the model tuning database 256, such as to control various hyperparameters for training. In various implementations, the system 200 can use the training management system 240 to configure the machine learning models 268 in a similar manner as described with reference to the second model 116 of FIG. 1, such as to train the machine learning models 268 using any of various data or combinations of data from the data repository 204.

### Application Session Management

FIG. 3 depicts an example of the system 200, in which the system 200 can perform operations to implement at least one application session 308 for a client device 304. For example, responsive to configuring the machine learning models 268, the system 200 can generate data for presentation by the client device 304 (including generating data responsive to information received from the client device 304) using the at least one application session 308 and the one or more machine learning models 268.

The client device 304 can be a device of a user, such as a technician or building manager. The client device 304 can include any of various wireless or wired communication interfaces to communicate data with the model system 260, such as to provide requests to the model system 260 indicative of data for the machine learning models 268 to generate, and to receive outputs from the model system 260. The client device 304 can include various user input and output devices to facilitate receiving and presenting inputs and outputs.

In some implementations, the system 200 provides data to the client device 304 for the client device 304 to operate the at least one application session 308. The application session 308 can include a session corresponding to any of the applications 120 described with reference to FIG. 1. For example, the client device 304 can launch the application session 308 and provide an interface to request one or more prompts. Responsive to receiving the one or more prompts, the application session 308 can provide the one or more prompts as input to the machine learning model 268. The machine learning model 268 can process the input to generate a completion, and provide the completion to the application session 308 to present via the client device 304. In some implementations, the application session 308 can iteratively generate completions using the machine learning models 268. For example, the machine learning models 268 can receive a first prompt from the application session 308, determine a first completion based on the first prompt and provide the first completion to the application session 308, receive a second prompt from the application 308, determine a second completion based on the second prompt (which may include at least one of the first prompt or the first completion concatenated to the second prompt), and provide the second completion to the application session 308.

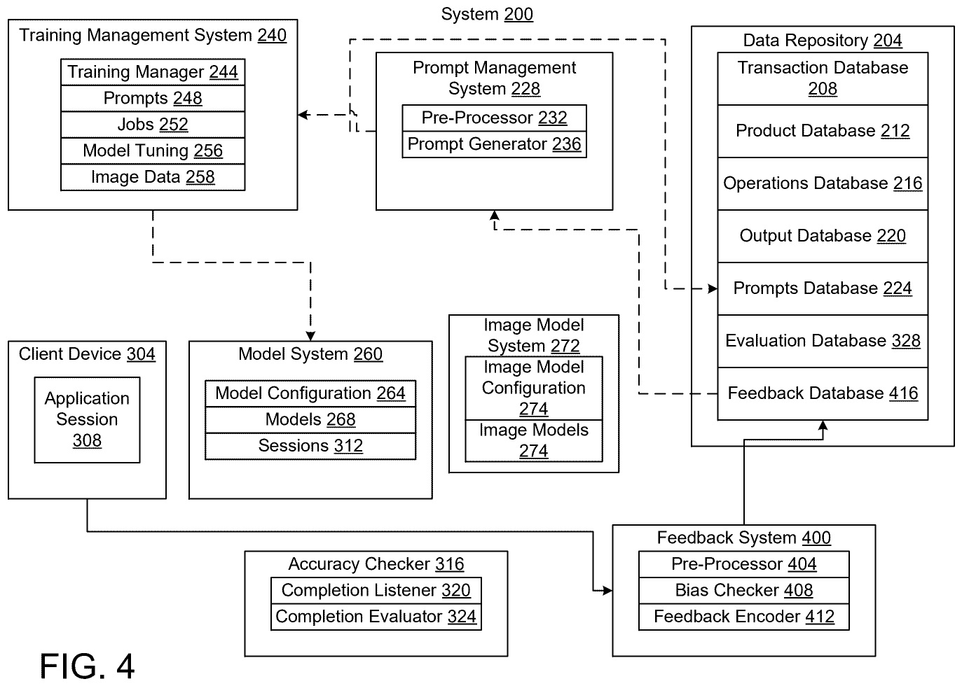

In some implementations, the model system 260 includes at least one sessions database 312. The sessions database 312 can maintain records of application session 308 implemented by client devices 304. For example, the sessions database 312 can include records of prompts provided to the machine learning models 268 and completions generated by the machine learning models 268. As described further with reference to FIG. 4, the system 200 can use the data in the sessions database 312 to fine-tune or otherwise update the machine learning models 268.

### Completion Checking

In some implementations, the system 200 includes an accuracy checker 316. The accuracy checker 316 can include one or more rules, heuristics, logic, policies, algorithms, functions, machine learning models, neural networks, scripts, or various combinations thereof to perform operations including evaluating performance criteria regarding the completions determined by the model system 260. For example, the accuracy checker 316 can include at least one completion listener 320. The completion listener 320 can receive the completions determined by the model system 320 (e.g., responsive to the completions being generated by the machine learning model 268 and/or by retrieving the completions from the sessions database 312).

The accuracy checker 316 can include at least one completion evaluator 324. The completion evaluator 324 can evaluate the completions (e.g., as received or retrieved by the completion listener 320) according to various criteria. In some implementations, the completion evaluator 324 evaluates the completions by comparing the completions with corresponding data from the data repository 204. For example, the completion evaluator 324 can identify data of the data repository 204 having similar text as the prompts and/or completions (e.g., using any of various natural language processing algorithms), and determine whether the data of the completions is within a range of expected data represented by the data of the data repository 204.

In some implementations, the accuracy checker 316 can store an output from evaluating the completion (e.g., an indication of whether the completion satisfies the criteria) in an evaluation database 328. For example, the accuracy checker 316 can assign the output (which may indicate at least one of a binary indication of whether the completion satisfied the criteria or an indication of a portion of the completion that did not satisfy the criteria) to the completion for storage in the evaluation database 328, which can facilitate further training of the machine learning models 268 using the completions and output.

### Feedback Training

FIG. 4 depicts an example of the system 200 that includes a feedback system 400, such as a feedback aggregator. The feedback system 400 can include one or more rules, heuristics, logic, policies, algorithms, functions, machine learning models, neural networks, scripts, or various combinations thereof to perform operations including preparing data for updating and/or updating the machine learning models 268 using feedback corresponding to the application sessions 308, such as feedback received as user input associated with outputs presented by the application sessions 308. The feedback system 400 can incorporate features of the feedback repository 124 and/or feedback trainer 128 described with reference to FIG. 1.

The feedback system 400 can receive feedback (e.g., from the client device 304) in various formats. For example, the feedback can include any of text, speech, audio, image, and/or video data. The feedback can be associated (e.g., in a data structure generated by the application session 308) with the outputs of the machine learning models 268 for which the feedback is provided. The feedback can be received or extracted from various forms of data, including external data sources such as manuals, service reports, or Wikipedia-type documentation.

In some implementations, the feedback system 400 includes a pre-processor 400. The pre-processor 400 can perform any of various operations to modify the feedback for further processing. For example, the pre-processor 400 can incorporate features of, or be implemented by, the pre-processor 232, such as to perform operations including filtering, compression, tokenizing, or translation operations (e.g., translation into a common language of the data of the data repository 204).

The feedback system 400 can include a bias checker 408. The bias checker 408 can evaluate the feedback using various bias criteria, and control inclusion of the feedback in a feedback database 416 (e.g., a feedback database 416 of the data repository 204 as depicted in FIG. 4) according to the evaluation. The bias criteria can include, for example and without limitation, criteria regarding qualitative and/or quantitative differences between a range or statistic measure of the feedback relative to actual, expected, or validated values.

The feedback system 400 can include a feedback encoder 412. The feedback encoder 412 can process the feedback (e.g., responsive to bias checking by the bias checker 408) for inclusion in the feedback database 416. For example, the feedback encoder 412 can encode the feedback as values corresponding to outputs scoring determined by the model system 260 while generating completions (e.g., where the feedback indicates that the completion presented via the application session 308 was acceptable, the feedback encoder 412 can encode the feedback by associating the feedback with the completion and assigning a relatively high score to the completion).

As indicated by the dashed arrows in FIG. 4, the feedback can be used by the prompt management system 228 and training management system 240 to further update one or more machine learning models 268. For example, the prompt management system 228 can retrieve at least one feedback (and corresponding prompt and completion data) from the feedback database 416, and process the at least one feedback to determine a feedback prompt and feedback completion to provide to the training management system 240 (e.g., using pre-processor 232 and/or prompt generator 236, and assigning a score corresponding to the feedback to the feedback completion). The training manager 244 can provide instructions to the model system 260 to update the machine learning models 268 using the feedback prompt and the feedback completion, such as to perform a fine-tuning process using the feedback prompt and the feedback completion. In some implementations, the training management system 240 performs a batch process of feedback-based fine tuning by using the prompt management system 228 to generate a plurality of feedback prompts and a plurality of feedback completion, and providing instructions to the model system 260 to perform the fine-tuning process using the plurality of feedback prompts and the plurality of feedback completions.

### Data Filtering and Validation Systems

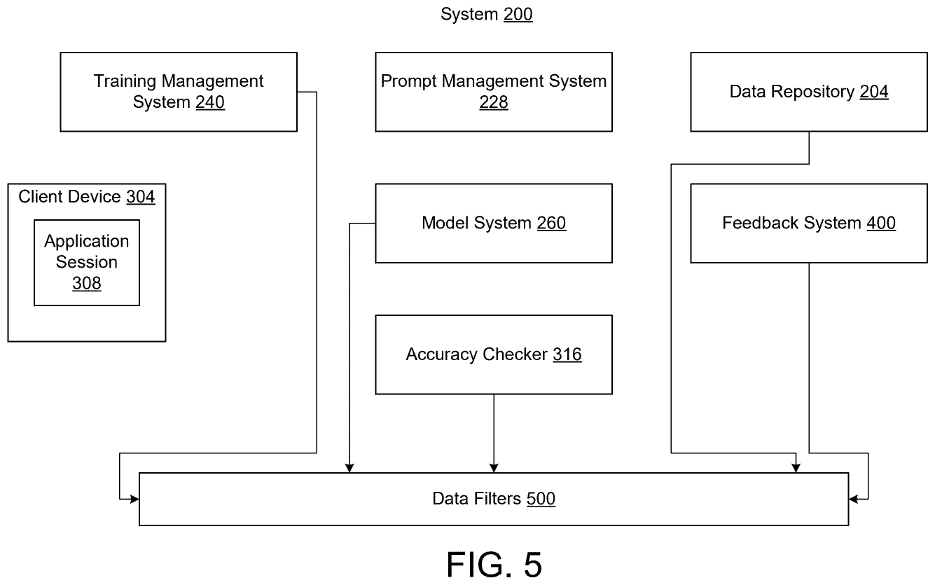

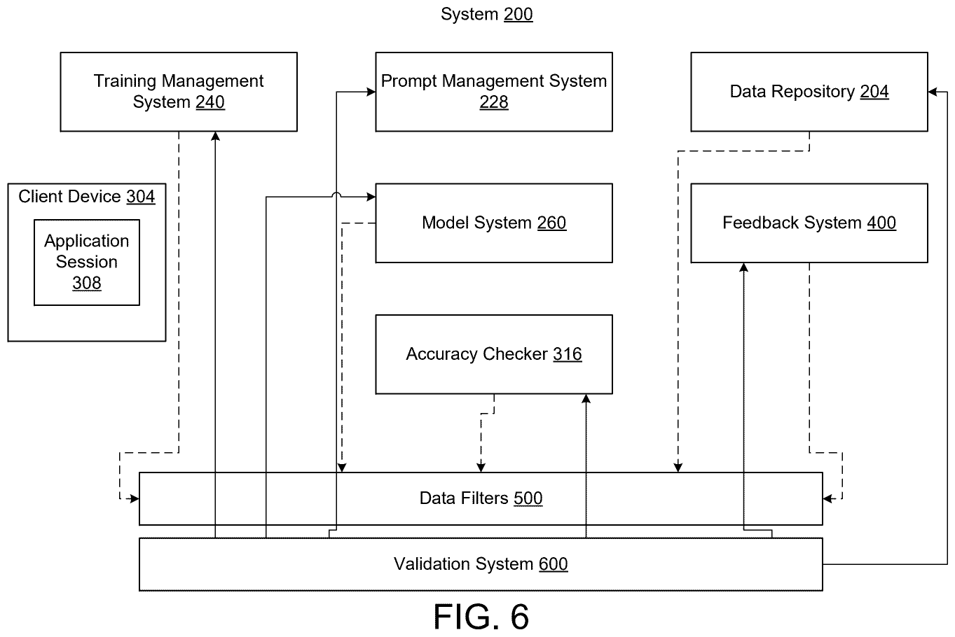

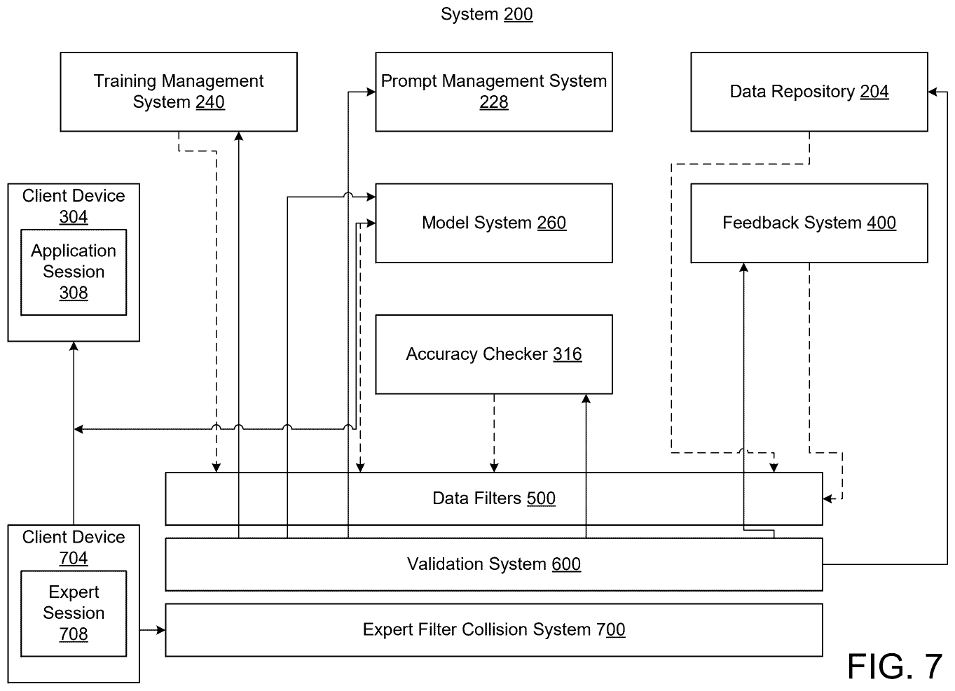

FIG. 5 depicts an example of the system 200, where the system 200 can include one or more data filters 500 (e.g., data validators). The data filters 500 can include any one or more rules, heuristics, logic, policies, algorithms, functions, machine learning models, neural networks, scripts, or various combinations thereof to perform operations including modifying data processed by the system 200 and/or triggering alerts responsive to the data not satisfying corresponding criteria, such as thresholds for values of data. Various data filtering processes described with reference to FIG. 5 (as well as FIGS. 6 and 7) can enable the system 200 to implement timely operations for improving the precision and/or accuracy of completions or other information generated by the system 200 (e.g., including improving the accuracy of feedback data used for fine-tuning the machine learning models 268). The data filters 500 can allow for interactions between various algorithms, models, and computational processes.

For example, the data filters 500 can be used to evaluate data relative to thresholds relating to data including, for example and without limitation, acceptable data ranges, setpoints, temperatures, pressures, flow rates (e.g., mass flow rates), or vibration rates for an item of equipment. The threshold can include any of various thresholds, such as one or more of minimum, maximum, absolute, relative, fixed band, and/or floating band thresholds.

The data filters 500 can enable the system 200 to detect when data, such as prompts, completions, or other inputs and/or outputs of the system 200, collide with thresholds that represent realistic behavior or operation or other limits of items of equipment. For example, the thresholds of the data filters 500 can correspond to values of data that are within feasible or recommended operating ranges. In some implementations, the system 200 determines or receives the thresholds using models or simulations of items of equipment, such as plant or equipment simulators, chiller models, HVAC-R models, refrigeration cycle models, etc. The system 200 can receive the thresholds as user input (e.g., from experts, technicians, or other users). The thresholds of the data filters 500 can be based on information from various data sources. The thresholds can include, for example and without limitation, thresholds based on information such as equipment limitations, safety margins, physics, expert teaching, etc. For example, the data filters 500 can include thresholds determined from various models, functions, or data structures (e.g., tables) representing physical properties and processes, such as physics of psychometrics, thermodynamics, and/or fluid dynamics information.

The system 200 can determine the thresholds using the feedback system 400 and/or the client device 304, such as by providing a request for feedback that includes a request for a corresponding threshold associated with the completion and/or prompt presented by the application session 308. For example, the system 200 can use the feedback to identify realistic thresholds, such as by using feedback regarding data generated by the machine learning models 268 for ranges, setpoints, and/or start-up or operating sequences regarding items of equipment (and which can thus be validated by human experts). In some implementations, the system 200 selectively requests feedback indicative of thresholds based on an identifier of a user of the application session 308, such as to selectively request feedback from users having predetermined levels of expertise and/or assign weights to feedback according to criteria such as levels of expertise.

In some implementations, one or more data filters 500 correspond to a given setup. For example, the setup can represent a configuration of a corresponding item of equipment (e.g., configuration of a chiller, etc.). The data filters 500 can represent various thresholds or conditions with respect to values for the configuration, such as feasible or recommendation operating ranges for the values. In some implementations, one or more data filters 500 correspond to a given situation. For example, the situation can represent at least one of an operating mode or a condition of a corresponding item of equipment.

FIG. 5 depicts some examples of data (e.g., inputs, outputs, and/or data communicated between nodes of machine learning models 268) to which the data filters 500 can be applied to evaluate data processed by the system 200 including various inputs and outputs of the system 200 and components thereof. This can include, for example and without limitation, filtering data such as data communicated between one or more of the data repository 204, prompt management system 228, training management system 240, model system 260, client device 304, accuracy checker 316, and/or feedback system 400. For example, the data filters 500 (as well as validation system 600 described with reference to FIG. 6 and/or expert filter collision system 700 described with reference to FIG. 7) can receive data outputted from a source (e.g., source component) of the system 200 for receipt by a destination (e.g., destination component) of the system 200, and filter, modify, or otherwise process the outputted data prior to the system 200 providing the outputted data to the destination. The sources and destinations can include any of various combinations of components and systems of the system 200.

The system 200 can perform various actions responsive to the processing of data by the data filters 500. In some implementations, the system 200 can pass data to a destination without modifying the data (e.g., retaining a value of the data prior to evaluation by the data filter 500) responsive to the data satisfying the criteria of the respective data filter(s) 500. In some implementations, the system 200 can at least one of (i) modify the data or (ii) output an alert responsive to the data not satisfying the criteria of the respective data filter(s) 500. For example, the system 200 can modify the data by modifying one or more values of the data to be within the criteria of the data filters 500.

In some implementations, the system 200 modifies the data by causing the machine learning models 268 to regenerate the completion corresponding to the data (e.g., for up to a predetermined threshold number of regeneration attempts before triggering the alert). This can enable the data filters 500 and the system 200 selectively trigger alerts responsive to determining that the data (e.g., the collision between the data and the thresholds of the data filters 500) may not be repairable by the machine learning model 268 aspects of the system 200.

The system 200 can output the alert to the client device 304. The system 200 can assign a flag corresponding to the alert to at least one of the prompt (e.g., in prompts database 224) or the completion having the data that triggered the alert.

FIG. 6 depicts an example of the system 200, in which a validation system 600 is coupled with one or more components of the system 200, such as to process and/or modify data communicated between the components of the system 200. For example, the validation system 600 can provide a validation interface for human users (e.g., expert supervisors, checkers) and/or expert systems (e.g., data validation systems that can implement processes analogous to those described with reference to the data filters 500) to receive data of the system 200 and modify, validate, or otherwise process the data. For example, the validation system 600 can provide to human expert supervisors, human checkers, and/or expert systems various data of the system 200, receive responses to the provided data indicating requested modifications to the data or validations of the data, and modify (or validate) the provided data according to the responses.

For example, the validation system 600 can receive data such as data retrieved from the data repository 204, prompts outputted by the prompt management system 228, completions outputted by the model system 260, indications of accuracy outputted by the accuracy checker 316, etc., and provide the received data to at least one of an expert system or a user interface. In some implementations, the validation system 600 receives a given item of data prior to the given item of data being processed by the model system 260, such as to validate inputs to the machine learning models 268 prior to the inputs being processed by the machine learning models 268 to generate outputs, such as completions.

In some implementations, the validation system 600 validates data by at least one of (i) assigning a label (e.g., a flag, etc.) to the data indicating that the data is validated or (ii) passing the data to a destination without modifying the data. For example, responsive to receiving at least one of a user input (e.g., from a human validator/supervisor/expert) that the data is valid or an indication from an expert system that the data is valid, the validation system 600 can assign the label and/or provide the data to the destination.

The validation system 600 can selectively provide data from the system 200 to the validation interface responsive to operation of the data filters 500. This can enable the validation system 600 to trigger validation of the data responsive to collision of the data with the criteria of the data filters 500. For example, responsive to the data filters 500 determining that an item of data does not satisfy a corresponding criteria, the data filters 500 can provide the item of data to the validation system 600. The data filters 500 can assign various labels to the item of data, such as indications of the values of the thresholds that the data filters 500 used to determine that the item of data did not satisfy the thresholds. Responsive to receiving the item of data from the data filters 500, the validation system 600 can provide the item of data to the validation interface (e.g., to a user interface of client device 304 and/or application session 308; for comparison with a model, simulation, algorithm, or other operation of an expert system) for validation. In some implementations, the validation system 600 can receive an indication that the item of data is valid (e.g., even if the item of data did not satisfy the criteria of the data filters 500) and can provide the indication to the data filters 500 to cause the data filters 500 to at least partially modify the respective thresholds according to the indication.

In some implementations, the validation system 600 selectively retrieves data for validation where (i) the data is determined or outputted prior to use by the machine learning models 268, such as data from the data repository 204 or the prompt management system 228, or (ii) the data does not satisfy a respective data filter 500 that processes the data. This can enable the system 200, the data filters 500, and the validation system 600 to update the machine learning models 268 and other machine learning aspects (e.g., generative AI aspects) of the system 200 to more accurately generate data and completions (e.g., enabling the data filters 500 to generate alerts that are received by the human experts/expert systems that may be repairable by adjustments to one or more components of the system 200).

FIG. 7 depicts an example of the system 200, in which an expert filter collision system 700 (“expert system” 700) can facilitate providing feedback and providing more accurate and/or precise data and completions to a user via the application session 308. For example, the expert system 700 can interface with various points and/or data flows of the system 200, as depicted in FIG. 7, where the system 200 can provide data to the expert filter collision system 700, such as to transmit the data to a user interface and/or present the data via a user interface of the expert filter collision system 700 that can be accessed via an expert session 708 of a client device 704. For example, via the expert session 708, the expert session 700 can enable functions such as receiving inputs for a human expert to provide feedback to a user of the client device 304; a human expert to guide the user through the data (e.g., completions) provided to the client device 304, such as reports, insights, and action items; a human expert to review and/or provide feedback for revising insights, guidance, and recommendations before being presented by the application session 308; a human expert to adjust and/or validate insights or recommendations before they are viewed or used for actions by the user; or various combinations thereof. In some implementations, the expert system 700 can use feedback received via the expert session as inputs to update the machine learning models 268 (e.g., to perform fine-tuning).

In some implementations, the expert system 700 retrieves data to be provided to the application session 308, such as completions generated by the machine learning models 268. The expert system 700 can present the data via the expert session 708, such as to request feedback regarding the data from the client device 704. For example, the expert system 700 can receive feedback regarding the data for modifying or validating the data (e.g., editing or validating completions). In some implementations, the expert system 700 requests at least one of an identifier or a credential of a user of the client device 704 prior to providing the data to the client device 704 and/or requesting feedback regarding the data from the expert session 708. For example, the expert system 700 can request the feedback responsive to determining that the at least one of the identifier or the credential satisfies a target value for the data. This can allow the expert system 708 to selectively identify experts to use for monitoring and validating the data.

In some implementations, the expert system 700 facilitates a communication session regarding the data, between the application session 308 and the expert session 708. For example, the expert session 700, responsive to detecting presentation of the data via the application session 308, can request feedback regarding the data (e.g., user input via the application session 308 for feedback regarding the data), and provide the feedback to the client device 704 to present via the expert session 708. The expert session 708 can receive expert feedback regarding at least one of the data or the feedback from the user to provide to the application session 308. In some implementations, the expert system 700 can facilitate any of various real-time or asynchronous messaging protocols between the application session 308 and expert session 708 regarding the data, such as any of text, speech, audio, image, and/or video communications or combinations thereof. This can allow the expert system 700 to provide a platform for a user receiving the data (e.g., customer or field technician) to receive expert feedback from a user of the client device 704 (e.g., expert technician). In some implementations, the expert system 700 stores a record of one or more messages or other communications between the sessions 308, 708 in the data repository 204 to facilitate further configuration of the machine learning models 268 based on the interactions between the users of the sessions 308, 708.

### Building Data Platforms and Digital Twin Architectures

Referring further to FIGS. 1-7, various systems and methods described herein can be executed by and/or communicate with building data platforms, including data platforms of building management systems. For example, the data repository 204 can include or be coupled with one or more building data platforms, such as to ingest data from building data platforms and/or digital twins. The client device 304 can communicate with the system 200 via the building data platform, and can feedback, reports, and other data to the building data platform. In some implementations, the data repository 204 maintains building data platform-specific databases, such as to enable the system 200 to configure the machine learning models 268 on a building data platform-specific basis (or on an entity-specific basis using data from one or more building data platforms maintained by the entity).

For example, in some implementations, various data discussed herein may be stored in, retrieved from, or processed in the context of building data platforms and/or digital twins; processed at (e.g., processed using models executed at) a cloud or other off-premises computing system/device or group of systems/devices, an edge or other on-premises system/device or group of systems/devices, or a hybrid thereof in which some processing occurs off-premises and some occurs on-premises; and/or implemented using one or more gateways for communication and data management amongst various such systems/devices. In some such implementations, the building data platforms and/or digital twins may be provided within an infrastructure such as those described in U.S. patent application Ser. No. 17/134,661 filed Dec. 28, 2020, Ser. No. 18/080,360, filed Dec. 13, 2022, Ser. No. 17/537,046 filed Nov. 29, 2021, and Ser. No. 18/096,965, filed Jan. 13, 2023, and Indian Patent Application number 202341008712, filed Feb. 10, 2023, the disclosures of which are incorporated herein by reference in their entireties.

### III. Generative AI-Based Systems and Methods for Equipment Servicing

As described above, systems and methods in accordance with the present disclosure can use machine learning models, including LLMs and other generative AI models, to ingest data regarding building management systems and equipment in various unstructured and structured formats, and generate completions and other outputs targeted to provide useful information to users. Various systems and methods described herein can use machine learning models to support applications for presenting data with high accuracy and relevance.

### Equipment Service Management Responsive to Fault Detection Using Machine Learning Models

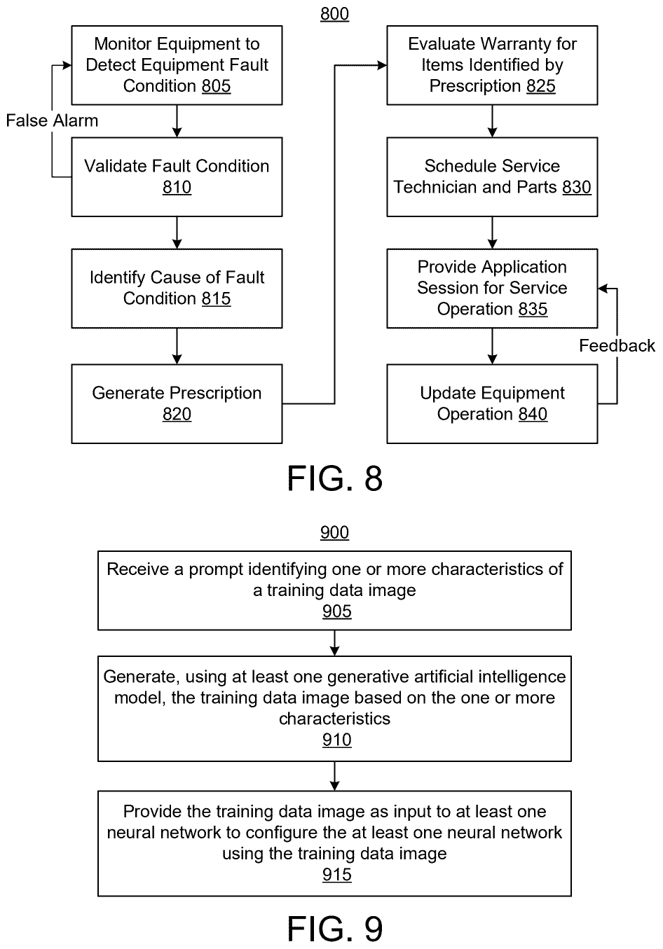

FIG. 8 depicts an example of a method 800. The method 800 can be performed using various devices and systems described herein, including but not limited to the systems 100, 200 or one or more components thereof. Various aspects of the method 800 can be implemented using one or more devices or systems that are communicatively coupled with one another, including in client-server, cloud-based, or other networked architectures.

At 805, a fault condition of an item of equipment can be detected. The fault condition can be detected responsive to manual and/or automated monitoring of various data sources regarding the item of equipment. In some implementations, the fault condition is detected responsive to an alarm notification from an alarm of the equipment or coupled with the equipment. For example, sensor data of the equipment or from a sensor directed to the equipment can be monitored by the alarm, and evaluated according to one or more alarm conditions (e.g., threshold values) to trigger the alarm notification. The fault condition can be detected responsive to user input indicative of the fault condition, or images or other data received indicative of the fault condition. The fault condition can be detected from images or video indicative of the condition, as discussed in conjunction with FIG. 9.

At 810, the fault condition can be validated. For example, the fault condition can be validated to determine whether the alarm notification corresponds to a false alarm. In some implementations, the fault condition can be validated by verifying the data used to detect the fault condition at a second point in time (e.g., subsequent to a first point in time at which the fault condition was initially detected), such as by evaluating the one or more alarm conditions using data regarding the equipment at the second point in time; this may include using the same or different data than the data used to initially detect the fault condition to validate the fault condition. The fault condition can be validated by providing the alarm notification to a device of a user, and requesting a confirmation (or indication of false alarm) from the user via the device. Responsive to the fault condition being identified as a false alarm, the equipment can be continued to be monitored.

At 815, a cause of the fault condition can be identified, such as by performing a root cause analysis. In some implementations, the cause is detected using a function that includes one or more algorithms, tables, simulations, or machine learning models described herein. For example, at least one of an identifier of the equipment, the fault condition, user text or speech identifying the fault condition (e.g., notes from any of a variety of entities, such as a facility manager, on-site technician, etc.), or data regarding the equipment used to detect the fault condition can be applied as input to the function to enable the function to determine an indication of a cause of the fault condition. For example, the function can include a table mapping various such inputs to one or more causes of fault conditions. The function can include a machine learning model configured using various forms of data described herein. For example, the machine learning model can include one or more classifiers, language models, or combinations thereof that are trained using data that includes information indicative of fault conditions and associated causes of fault conditions.

At 820, a prescription is generated based on the cause of the fault condition. For example, one or more of the cause of the fault condition, the fault condition, and an identifier of the equipment can be provided to a language model to cause the language model to generate the prescription. The prescription can have a natural language format. The prescription can indicate one or more actions for a service technician to perform to verify, service, and/or repair the fault condition, such as instructions for tools and/or parts to use for the item of equipment. The language model can include any of various models described herein that are configured, using training data representative of prescriptions. The prescription can be generated for presentation using various output modalities, such as text, speech, audio, image, and/or video, including in real-time, conversational, or asynchronous formats.

In some implementations, generating the prescription includes conditioning or guiding the language model to generate the prescription based on a class of at least one of the service technician or the site at which the item of equipment is present. For example, the language model can have its configuration (e.g., training, etc.) modified according to labels of identifiers or classes of technicians, sites, types of equipment, or other characteristics relating to the item of equipment and/or the service technician, which can enable the prescription to be generated in a manner that is more accurate and/or relevant to the service to be performed.

At 825, a warranty is evaluated based on one or more items (e.g., the equipment, parts or tools for servicing the equipment) identified by the prescription. For example, the warranty can be retrieved from various sources, such as a contract database associated with the entity that maintains the site, according to an identifier of the type of equipment, from the service request, or various combinations thereof. The prescription (or the service request) can be parsed to identify one or more items, such as items of equipment, identified by the prescription. For example, the item of equipment for which the service request is generated can be identified from the prescription, and compared with the warranty (e.g., using natural language processing algorithms, etc.) to identify one or more warranty conditions assigned to the item of equipment. The warranty conditions can indicate, for example, timing criteria for authorizing and/or payment for servicing the item of equipment by a vendor or supplier of the item of equipment. Responsive to the warranty conditions being satisfied (e.g., a termination of the warranty not being met), various actions can be performed to trigger servicing of the item of equipment. In some implementations, one or more warranty conditions are evaluated prior to, during, and or subsequent to generation of the prescription, such as to allow the prescription to be generated to incorporate one or more outputs of the evaluation of the warranty (or avoid computational resources for generating the prescription responsive to the warranty conditions not being satisfied).

At 830, scheduling of deployment of at least one of a service technician or one or more parts identified by the prescription can be performed. In some implementations, the prescription can identify the service technician, such as to select the service technician from a plurality of candidate service technicians according to an expertise that the service technician is labeled with, and which corresponds to the item of equipment. Scheduling deployment of the one or more parts can including identifying a provider of the one or more parts and assigning the one or more parts to a vehicle (e.g., trucks) for delivering the one or more parts to the site of the item of equipment. By using the language model to generate the prescription-which identifies the one or more parts—the one or more parts that are delivered to the site can be more accurately identified, which can reduce resource usage and/or wasted space or weight on the vehicle. In some implementations, scheduling deployment includes generating a service ticket indicative of the service to be performed, such as to identify the service technician, the parts, and/or the item of equipment.

Depending on the determined prescription, the scheduling can include automated servicing of the item of equipment, such as to provide commands to adjust parameters of the item of equipment to a controller of the item of equipment. The scheduling can include providing instructions for performing remote service, such as to provide instructions to a service technician to use on-site tools and/or parts, or manual adjustment of the item of equipment, to service the item of equipment (e.g., to avoid a truck deployment or truck roll to the site).

At 835, an application session for a service operation corresponding to the service request (and the prescription) can be provided. In some implementations, the application session is provided via a device of the service technician. For example, the device can provide one or more credentials to access the application session (e.g., credentials that uniquely identify the service technician). The application session can present information to the service technician in any of various conversational, messaging, graphical, real-time, and/or asynchronous formats. The application session can receive one or more prompts from the device (e.g., from a user input device of the device), and provide the one or more prompts to the language model to cause the language model to provide corresponding completions responsive to the one or more prompts. For example, the device can receive text or image data (among other formats) as inputs provided by actions of the user (e.g., via an input interface of the device; by the user controlling a camera of the device), and provide the inputs as prompts to the language model. The application session can present the completions via the device to facilitate guiding the service technician through the actions to perform to service the item of equipment. In some implementations, the application session automatically (e.g., responsive to detecting a condition for escalating the guidance to a human expert) or manually (e.g., responsive to user input requesting guidance from a human expert) can establish a communication session between the device and a device of a human expert to provide further guidance to the service technician; the language model can provide various information such as the service request, prescription, and/or communications between the user and the language model via the application session to the device of the human expert, and can label various portions of the communications as potential causes of the escalation. The application session can be implemented as a virtual assistant, such as to provide information such as instruction manuals or technical reports regarding the item of equipment, responsive to requests from the service technician inputted at the device of the service technician.

At 840, operation of the item of equipment can be updated responsive to one or more actions performed by the service technician. For example, various parameters of operation of the item of equipment, such as setpoints, can be updated according to the one or more actions.

In some implementations, information from the service request, prescription, and application session processes can be used to perform analytics regarding entities that maintain sites and items of equipment (e.g., to evaluate customer churn). For example, information including unstructured data (e.g., service reports) regarding items of equipment and entity engagement or disengagement (e.g., deals) can be correlated to identify patterns regarding ways that service can be performed to maintain or increase the likelihood of increasing performance of one or more items of equipment of the entity, completion of deals or of maintaining engagement with the entity.

### IV. AI-Based Risk Monitoring and Training Data Generation for AI-Based Risk Monitoring

Referring further to FIG. 2, the system 200 can include at least one image model system 272. The image model system 272 can include an image model configuration processor 274 and one or more image models 278. The image models 278 can include a neural network, such as a neural network configured to perform computer vision operations on received image data (e.g., from a camera and/or video camera, such as images, an image stream, and/or a video stream). The image models 278 can include a machine learning model. The image models 278 can be used to detect one or more conditions in an image or video, including but not limited to conditions that satisfy one or more risk criteria. The conditions can be associated with one or more items of equipment, building management systems, construction, installation, and/or servicing operations, or various combinations thereof. The one or more risk criteria may include risks to a person, equipment, vehicle, environment, and/or building. The conditions may satisfy the one or more risk criteria by representing a risk to a person, equipment, vehicle, environment, and/or building. For example, the conditions can include, but are not limited to, a person underneath a crane load, a person welding without a face mask, unsafe scaffolding, or unsafe behavior on scaffolding. The image models 278, upon configuration, can output an indication of the detected condition, such as to provide a bounding box and/or text alert that indicates the detected condition.

In some implementations, performance of the one or more image models 278, such as precision, accuracy, and/or recall associated with detecting whether the one or more conditions are present in one or more images or video, can depend on the training data used to configure the image models 278, such as the presence of objects in the images/video that represent the conditions to be detected. For example, to configure the image model 278 to detect whether a person is at a location underneath a crane load that does or does not satisfy the risk criteria, it may be useful to have images that represent such conditions. However, various such conditions may be dangerous or otherwise should not be arranged in real-world environments, making it difficult to generate sufficient training data to effectively configure the image models 278.

Systems and methods in accordance with the present disclosure can use the model system 260, such as the machine learning models 268 (e.g., via application session 308), to generate training data for use in configuring the image models 278. The model system 260 can generate synthetic or simulated training data having one or more characteristics representative of conditions, such as conditions satisfying one or more risk criteria. For example, the model system 260 can generate a synthetic training image having a characteristic of an unsecured crane load above a person. The model system 260 can receive (e.g., via the application session 308), an input indicating one or more characteristics for generating the training data. In an example, the model system 260 can receive input indicating a characteristic of an unsecured crane load above a person. In an example, the model system 260 can receive input indicating a characteristic of dangerous crane operation or a characteristic of dangers to persons from dangerous crane operation. The model system 260 can receive input indicating characteristic(s) associated with risk criteria for one or more persons and one or more objects in one or more scenes of a building environment, work site environment (e.g., construction environment), and/or a workplace environment.

The model system 260 can receive input for the characteristics in any of various formats and data types, including unstructured (e.g., freeform) formats and any of text, audio, speech, image, and/or video data types, and use the model system 260 to process the inputs to identify the characteristics and generate the training data according to the characteristics. The model system 260 can receive the input in a variety of formats. In some implementations, the model system 260 receives the input as an API call. In some implementations, the model system 260 receives the input as a set of characteristics or conditions. In some implementations, the model system 260 receives an input document, such as an employee handbook, and the model system 260 parses the input document to determine the characteristics. In some implementations, the model system 260 can use the application session 308 to provide a conversational interface to facilitate generating useful training data. In an example, the application session 308 provides a conversational interface (e.g., with a chatbot) to receive the input, to request clarification of the input, and/or explain how the training data is generated based on the input.

In some implementations, the model system 260 can generate variations on training data to further facilitate configuration of the image models 278. In an example, the model system 260 can receive the input, determine variations on the input, and use the input and the variations on the input for generating the training data. In an example, the model system 260 can use the application session 308 to provide the conversational interface to receive the input, suggest variations on the input, and receive confirmation of or adjustments to the variations of the input. In some implementations, the model system 260 generates the variation to include additional views of a scene corresponding to the input. For example, the model system 260 (e.g., using machine learning models 268 as described further herein) can generate a first image corresponding to a first view (e.g., first perspective, first camera view) of the scene, and can generate a second image corresponding to a second view of the scene, the second view being different from the first view. This can allow for the model system 260 to more rapidly generate more useful training data for configuration of the one or more image models 278, such as to configure the image models 278 to be more effective at detecting conditions that may not be directly represented in real world-based training images.

The model system 260 can implement various processes to provide transparency for generating the training data (e.g., by being configured to be queried for explanations of why the training data images are generated in various ways), which can facilitate iteratively updating the training data image until it satisfies a user's criteria in fewer iterations (e.g., using fewer computational resources).

The machine learning models 268 can include one or more image generators and/or one or more video generators, including but not limited to one or more diffusion models, latent diffusion models, and/or GANs. The completions generated by the machine learning models 268 can include image data 258. In an example, the prompts 248 include prompts for generating images having one or more characteristics. The one or more characteristics can be associated with a condition, including, but not limited to, conditions that satisfy one or more risk criteria associated with a risk. The risk can be a risk to a person, building system, device, or piece of equipment. The machine learning models 268 can generate the image data 258 having the characteristics and/or representing the condition. The image data 258 can include one or more images, videos, and/or image (or video) models, such as 2D or 3D representations of at least one of an object or a scene corresponding to the one or more characteristics. The machine learning models 268 can generate the image data 258 to include an image having the characteristics and/or representing the condition and an image not having the characteristics, or having an opposite of the characteristics. In an example, the prompts 248 include a prompt to generate an image of a person welding without a face mask. In this example, the machine learning models 268 can generate an image of a person welding without a face mask and an image of a person welding with a face mask. In an example, the prompts 248 include a prompt to generate an image of a fan with wiring that has been chewed by rodents. In this example, the machine learning models 268 can generate an image of wiring that has been chewed by rodents, an image of undamaged wiring, and an image of wiring that is worn but not chewed by rodents.

In some implementations, the machine learning models 268 can map the one or more characteristics to a condition such as a condition that satisfies one or more risk criteria associated with a risk. The machine learning models 268 can generalize the one or more characteristics to the condition and/or determine specific conditions corresponding to the one or more characteristics. This can include, for example, retrieving predefined labels of the characteristics, conditions, and/or risk criteria from the prompt, or processing the prompt using one or more language models and/or natural language processing models of the machine learning models 268 to generate the predefined labels. In an example, the prompts 248 include a prompt to generate an image of a person engaging in risky behavior when welding or an image of a person violating one or more predefined rules for safe welding. In this example, the machine learning models 268 can generate an image of a person welding without a face mask and/or an image of a person welding without wearing gloves. The machine learning models 268 can generate several variants of a person welding without a face mask and/or of a person welding without wearing gloves. In another example, the prompts 248 include a prompt to generate an image of a fan with wiring that poses a spark risk. In this example, the machine learning models 268 can generate images of a fan with improperly installed wiring, wiring with worn sheaths to expose wires, and/or wiring that has been chewed by rodents to expose wires, as well as several variants thereof. In this way, the machine learning models 268 can generate multiple variations of images having the characteristics and/or depicting the condition.

The image data 258 can be used for training the image models 278. The training management system 240 can provide the image data 258 to the image model configuration processor 264. The image model configuration processor 264 can apply the image data 258 to the image models 278 to configure the image models 278. The training manager 244 can control training by the image model configuration processor 274 based on model tuning parameters in the model tuning database 256, such as to control various hyperparameters for training. In some embodiments, the image models 278 can be included in the model system 260 and the model configuration processor 264 can apply the image data 258 to the image models 278 to configure the image models 278. In some embodiments, the image model configuration processor 274 and/or the model configuration processor 264 apply the prompts 248 to the image models 278 and/or label the image data 258 with the prompts 248. In some implementations, the image data 258 are labeled with the prompts 248. In some implementations, the image data 258 are labeled with the one or more characteristics or condition.

In some implementations, training the image models 278 includes training the image models 278 in a supervised training approach. In an example, training the image models 278 includes executing the image models 278 using as input the image data 258 to generate a predicted condition, comparing the predicted condition to a labeled condition, and applying a loss function to reduce a distance or a difference between the predicted condition and the labeled condition. In an example, training the image models 278 includes executing the image models 278 using as input the image data 258 to generate a predicted condition, comparing the predicted condition to a labeled prompt, and applying a loss function to reduce a distance or a difference between the predicted condition and the labeled prompt. In some implementations, training the image models 278 includes training the image models 278 in an adversarial training approach. In an example, training the image models 278 includes executing the image models 278 using as input the image data 258 to generate a predicted condition, executing an adversarial model using as input the predicted to condition to generate a determination of whether the predicted condition is a generated condition or an actual condition, and updating the image models 278 such that the adversarial model determines that the output of the image models 278 are actual conditions.

The image models 278 can be trained using the image data 258 to detect images and video having the characteristic. In some embodiments, the image models 278 can be used to identify conditions associated with building management including, but not limited to, conditions that satisfy one or more risk criteria. In an example, the image models 278 can be used to monitor video and detect risky behaviors and/or equipment malfunctions. In an example, the image models 278 identify a person welding without a face mask in a video. In another example, the image models 278 identify, from an image, wiring that has been chewed by rodents and which represents a fire or spark risk.

FIG. 9 is a flow diagram of a method 900 of detecting conditions using machine learning models. The method 900 can be performed using various devices and systems described herein, including but not limited to the systems 100, 200 or one or more components thereof. Various aspects of the method 900 can be implemented using one or more devices or systems that are communicatively coupled with one another, including in client-server, cloud-based, or other networked architectures.

At 905, a prompt is received identifying one or more characteristics of a training data image. The prompt can be to generate the training data having the one or more characteristics. Receiving the prompt can include generating a query associated with the one or more characteristics and receiving a response to the query. The prompt can be based at least in part on the response. The query can be generated as part of a dynamic query session in which queries are generated based on responses received from a user. The dynamic query session can refine the one or more characteristics to generate the prompt or refine the prompt. In an example, the prompt is to generate an image of a person welding in an unsafe manner, and the dynamic query session includes refining questions to clarify that the image should depict a person welding without safety equipment, such as without a face mask or without gloves.

At 910, the training data image is generated based on the one or more characteristics using at least one generative artificial intelligence model. The training data image can be an image, a plurality of images, a video, and/or a plurality of videos with or without sound.

The generative AI model can be pre-configured using images and/or videos associated with building management. The generative AI model can be pre-configured by the model updater 108 of FIG. 1, the model configuration processor 264, and/or the image configuration processor 274, as discussed herein. The generative AI model can be preconfigured based on model tuning parameters in the model tuning database 256, as discussed herein. The images can include a plurality of images and the videos can include a plurality of videos. The generative AI model can be fine-tuned to accurately generate images or video including building management elements such as building systems, building architecture, equipment, piping, and/or wiring in various phases of construction and/or maintenance. The images or video associated with building management can also include one or more people installing, maintaining, inspecting, or repairing building elements and/or equipment. The images or video can include construction, installation, service, management, monitoring, and/or repair of one or more items of equipment. In an example, the generative AI model can be pre-configured using images or videos of HVAC equipment, installation of HVAC equipment, maintenance of HVAC equipment, damaged HVAC equipment, and malfunctioning HVAC equipment. In this example, the images or videos can include one or more people installing, maintaining, and/or inspecting the HVAC equipment. The generative AI model can be pre-configured using images or videos such that the generative AI model accurately generates images or video of equipment building systems, building architecture, equipment, piping, and/or wiring in various phases of construction and/or maintenance as well as the processes of installing, maintaining, inspecting, or repairing building elements and/or equipment.

The generative AI model can include a first generative AI model for generating a first image and a second generative AI model for refining the first image to generate the training data. The second generative AI model can be pre-configured using data associated with building system components or building management. The second generative AI model can be trained to generate images or video associated with building system components or building management. In an example, the second generative AI model is trained using images and/or video of building systems and/or equipment associated with building management. The second generative AI model can be trained to correct portions of the first image associated with building system components or building management. The second generative AI model can be trained using images generated by the first generative AI model as the input and images of building system components as the target output. In an example, the second generative AI model can be trained using images generated by the first generative AI model that depict a scaffold as the input and pictures of an actual scaffold as the target output. The second generative AI model can be used to correct, modify, or refine images generated by the first generative AI model. In an example, the first image includes a chiller. The second generative AI model can refine the first image by adjusting, modifying, or replacing the chiller in the first image to produce the training image including an accurate chiller. The chiller can be a specific chiller associated with a particular system. The second generative AI model can be pre-configured to represent building system components or building management procedures accurately and/or to specify particular building system components or building management procedures for inclusion in the training image. In some embodiments, the second generative AI model can receive user input corresponding to elements in the first image for refining.

The one or more characteristics can correspond to a risk criteria. The risk criteria can correspond to a state of one or more objects to be represented in the training data image. For example, the risk criteria can indicate one or more parameters of the one or more objects, such as temperature, pressure, load, capacity, current or expected demand, position (as well as velocity and/or acceleration), orientation, rates of change of any of various such parameters, or various combinations thereof. The risk criteria can indicate relative values of any of various such parameters, such as relative positions or orientations amongst a plurality of objects (including human subject(s)) depicted or otherwise represented in the training data image. For example, responsive to receiving a prompt of “Create a training data image in which a person is under a scaffold,” the generative AI model can generate the training data image to meet risk criteria such that a scaffold is depicted and a person is depicted in a relative position of being under the scaffold. The characteristics can correspond to an identifier or type of camera or other image sensor to be used for providing image data to the neural network (e.g., for real-time alerting according to real-world events), which can enable the generative AI model to generate training data images that more closely correspond to camera parameters of the image data to be used by the neural network for detecting the conditions represented by the training data images. Images containing conditions that satisfy one or more risk criteria may be dangerous or impractical to obtain by conventional means, such as positioning a person beneath a scaffold and taking a picture. Generating images depicting conditions satisfying one or more risk criteria solves the technical problem of a lack of training data for detecting such conditions.

One or more objects in the training data image can be associated with the risk criteria. One or more objects in the training data image can be arranged according to the one or more characteristics. In an example, the characteristics can include a pipe leaking, or positioned so as to be able to leak, onto an electrical junction box. In this example, the training data image can include the leaking pipe arranged above the electrical junction box. In another example, the characteristics can include tools that represent a trip hazard and the training data image can include the tools arranged in a hallway such that they pose a trip hazard. The one or more characteristics can include one or more of relative positions of one or more objects, relative orientations of one or more objects, and relationships between an object and a person. In an example, the one or more characteristics can include an explosion risk and the training data image can include an acetylene torch pointed towards an oxygen tank. In another example, the one or more characteristics can include a head injury risk and the training data image can include a person below a crane load. In another example, the one or more characteristics can include an electrical shock risk and the training data image can include a person near an open electrical box that is connected to power. In this example, the training data image can include a switch whose orientation or position indicates that the electrical box is connected to power.

The at least one generative AI model can generate an additional training image. The additional training image can be a variant of the training data image. The additional training image can have the same characteristics as the training data image. The additional training image may differ from the training data image in one or more aspects, including but not limited to lighting, angle, composition, time of day, number of people, color, lens, image quality. In an example, the training data image includes a damaged chiller as seen from below in the morning and the additional training image includes a damaged chiller as seen from the side in the evening. In another example, a prompt includes an electrician splicing wires, the training data image includes an electrician wearing a red shirt splicing wires in a hall lit by fluorescent lights as seen by a low-quality CCTV camera, and the additional training image includes an electrician wearing a blue shirt splicing wires in a hall lit by LED lights as seen by a high-quality CCTV camera. The additional training image can be used to generate training data that focuses on the characteristics while accounting for variations in details other than the characteristics. In this way, the training data can be generalized for variations in image characteristics other than characteristics associated with the risk criteria. In this way, the training data can provide more effective training on the characteristics associated with the risk criteria, while avoiding confounding variables.

The at least one generative AI model can generate an additional training image based one or more additional characteristics. The one or more additional characteristics can be based on the one or more characteristics. The additional training image can have at least one characteristic in common with the training data image. The one or more additional characteristics can have at least one characteristic in common with the training data image. The one or more additional characteristics can have at least one characteristic that the training data image does not have. In an example, the one or more additional characteristics can be based on the one or more characteristics such that the one or more additional characteristics are the same as the one or more characteristics except for one characteristic. In an example, the training data image can be of an improperly secured crane load above a piece of building equipment and the additional training image can be of an improperly secured crane load above a person. In some embodiments, the one or more additional characteristics are received as user input. In some embodiments, the one or more additional characteristics are automatically generated. The additional training image can be labeled with the one or more additional inputs.

The training data image can be labeled with one or more labels corresponding to the one or more characteristics. In some embodiments, the one or more labels include the prompt. The one or more labels can include information which was used to generate the prompt. In an example, an employee handbook which outlines workplace risks is used to generate the prompt and the training data image is labeled with language in the handbook corresponding to the characteristics of the training data image used in the prompt. In some embodiments, at least one of the one or more labels identifies a portion of the training data image associated with at least one of the one or more characteristics. In an example, the one or more labels identify different objects and people and a risk associated with an arrangement, orientation, or relationship between the objects and/or people. In an example, the one or more labels include a label identifying a person, a label identifying a crane load, and a label identifying a position of the person under the crane load. In some implementations, the application session that receives inputs identifying the characteristics can provide text and/or graphical user interfaces to receive inputs (e.g., from a user) for modifying the objects depicted in the training data image according to the inputs, such as to adjust positions of the objects. The generative AI model can use the inputs and/or the adjustments indicated by the inputs as model training data, as well as the initial inputs and/or characteristics used to generate the training data image, to update the generative AI model, such as to make the generative AI model capable of more accurately generating training data images that are indicative of the characteristics.

At 915, the training data image is provided as input to at least one neural network to configure the at least one neural network using the training data image. In some embodiments, the at least one generative artificial intelligence can be a machine learning model, and the machine learning model can be trained using the training data image. The at least one neural network can be trained to detect the characteristics in images and/or video. In an example, the at least one neural network is used to detect conditions that satisfy one or more risk criteria associated with building management in images and/or video. The training data image can be labeled with the prompt, characteristics, and/or condition. Training the at least one neural network can include a supervised training approach and/or an adversarial training approach, as discussed herein.

### V. AI-Based Risk Monitoring with Synthetic Training Image Generation and Blending Using Generative Artificial Intelligence

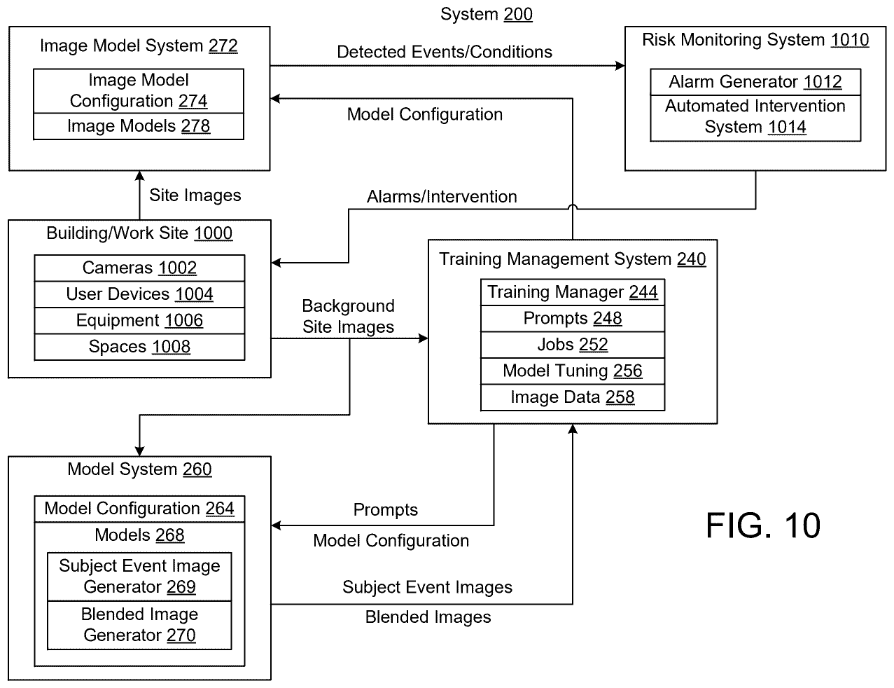

Referring now to FIG. 10, a block diagram illustrating a portion of the system 200 in greater detail is shown, according to an exemplary embodiment. In the embodiment of FIG. 10, the system 200 may operate similarly as previously described, with the exception that the system 200 generates synthetic blended images of events or other conditions which could occur at the building/work site 1000 and uses the synthetic blended images to train the image models 278, rather than relying on only actual images of such events or conditions (e.g., images recorded by cameras). Advantageously, the generation and use of synthetic blended images for model training allows the system 200 to generate a more robust set of image data 258 for use in training the image models 278 (e.g., showing a wider variety of detectable events or conditions, variations in lighting or other conditions, showing rare events/conditions, etc.) than would be possible if only actual images were used. This allows the image models 278 to more accurately detect various types of events or conditions occurring at the building/work site 1000 and initiate automated alarms or interventions (e.g., corrective actions, responses, etc.) upon detecting such events or conditions.

In brief overview, the system 200 may obtain background site images of the building/work site 1000 from cameras 1002 or user devices 1004 installed at the building/work site 1000. The model system 260 may generate synthetic images of various types of detectable events or conditions which could occur at the building/work site 1000 (e.g., dangerous conditions, safety violations, equipment faults, etc.) using one or more generative AI models such as the models 268 described herein. Such images are referred to herein as subject event images. In some embodiments, the model system 260 generates the subject event images in response to prompts 248 provided by the training management system 240 (e.g., “generate 100 images of a construction worker not wearing a hardhat”). In other embodiments, the model system 260 generates the subject event images by extracting portions of actual images depicting the subject events in different settings/locations. The model system 260 may blend or combine the background site images with the subject event images to generate blended images of the subject events occurring at the building/work site 1000. The blended images may be provided to the training management system 240 and used to train the image models 278, which may include AI models, machine learning models, and/or neural network models as previously described. The trained image models 278 may then be used by the risk monitoring system 1010 to detect the subject events occurring at the building/work site 1000. In response to detecting a subject event, the risk monitoring system 1010 may generate an alarm and/or initiate an automated intervention to address or correct an anomalous or risky condition indicated by the detected subject event. These and other features of the system 200 are described in greater detail below.

Still referring to FIG. 10, the system 200 is shown to include many of the same components shown in FIG. 2, which may perform the same or similar functions as described with reference thereto. The system 200 is further shown to include a building/work site 1000 and a risk monitoring system 1010. The building/work site 1000 may include one or more buildings (e.g., office buildings, factories, manufacturing facilities, plants, etc.), spaces within a building (e.g., rooms, floors, zones, etc.), spaces outside a building (e.g., outdoor areas, parking lots, entrances, rooftops, etc.), construction sites (e.g., building construction sites, vehicle construction sites, equipment construction sites, etc.), or other types of work sites (e.g., oil platforms, indoor work sites, outdoor work sites, etc.). The building/work site 1000 may include various cameras 1002 (e.g., video cameras, still image cameras, surveillance cameras, security cameras, etc.) positioned to capture images (e.g., still images, videos, etc.) of the building/work site 1000. In some embodiments, the building/work site 1000 includes user devices 1004 (e.g., mobile devices, cellular phones, hand-held cameras, etc.) with cameras capable of capturing images of the building/work site 1000.

The building/work site 1000 is further shown to include equipment 1006 and spaces 1008. The equipment 1006 can include HVAC equipment, building equipment, construction equipment, factory equipment, security equipment, vehicles, or other types of equipment capable of being used at the building/work site 1000. The spaces 1008 may include one or more indoor or outdoor spaces in which the equipment 1006 or other objects of interest are located. The spaces 1008 may also include people (e.g., employees, workers, etc.) who work at the building/work site 1000. The cameras 1002 and user devices 1004 may capture images of the equipment 1006, spaces 1008, workers at the building/work site 1000, other objects of interest at the building/work site 1000, and/or various events occurring at the building/work site 1000. The images captured by the cameras 1002 and/or the user devices 1004 can be provided to other components of the system 200 (e.g., the training management system 240, the image model system 272, etc.) and used to train the image models 278 and/or to detect various events or conditions occurring at the building/work site 1000, as described herein.

In some embodiments, the cameras 1002 and/or user devices 1004 at the building/work site 1000 capture background site images of the building/work site 1000. The background site images may include, for example, images of the building/work site 1000 in the absence of workers, temporary equipment, and/or other entities that are not present when the building/work site 1000 is not occupied or when events of interest are not occurring at the building/work site 1000. For example, the background site images of an office building may include images of the spaces 1008 of the office building when unoccupied (e.g., without any employees or workers present). The background site images may include images of the equipment 1006 of the building/work site 1000 when the equipment 1006 are inactive or when the equipment 1006 are being used or operated under normal conditions (e.g., the absence of a fault or other detectable event occurring at the building/work site 1000). As another example, the background images of a factory or plant may include images of various spaces 1008 and/or equipment 1006 of the factory when the equipment 1006 are inactive and/or when the equipment 1006 are operating under normal conditions. As yet another example, the background images of a construction site may include images of various equipment 1006 and/or spaces 1008 of the construction site without any construction workers present, images of the equipment 1006 and/or spaces 1008 of the construction site when the equipment 1006 of the construction site are not being used, and/or images of equipment 1006 and/or spaces 1008 of the construction site when the equipment 1006 are being used or operated under normal conditions. In general, the background site images depict the background environment of the building/work site 1000 in the absence of events or other conditions that the system 200 is configured to detect.

Still referring to FIG. 10, the model system 260 is shown to include the model configuration 264 and the models 268, which may perform some or all of the same or similar functions as described with reference to FIG. 2. The models 268 are further shown to include two additional components, a subject event image generator 269 and a blended image generator 270. The subject event image generator 269 may include one or more AI models (e.g., generative AI models), machine learning models, neural network models, or other types of models configured to generate a portion of the image data 258 (i.e., subject event images) for use in training the image models 278 of the image model system 272.

The subject event images may depict various types of conditions or events which could potentially occur at the building/work site 1000, referred to herein as subject events. Subject events may include, for example, worker safety violations such as a construction worker not wearing a hard hat, hospital employees not wearing a face mask or gloves, a factory worker operating factory machinery without taking proper safety precautions, or any other type of safety violation. Subject events may include faults or abnormal operation of the equipment 1006, such as operating in a manner indicative of an active fault in the equipment 1006 or exhibiting behavior indicating that the equipment 1006 may experience a fault in the future, improper configuration or use of the equipment 1006 (e.g., improper wiring, operating the equipment 1006 in a manner other than the intended use, etc.). In some embodiments, subject events may include other types of detectable events such as fires, water leaks, security events (e.g., unauthorized persons, open windows or doors, suspicious behavior by building occupants, etc.), or any other type of event which may trigger an alarm or automated intervention. The subject event images may include images (e.g., still images, videos, etc.) of the subject events in settings other than the building/work site 1000 or abstracted from any setting (e.g., having a blank or generic background, having no background, etc.).

In some embodiments, the subject event image generator 269 generates synthetic or simulated images having one or more characteristics representative of conditions or events which could occur at the building/work site 1000, such as conditions or events satisfying one or more risk criteria. For example, the subject event image generator 269 can receive (e.g., via the application session 308), an input indicating one or more characteristics for generating the subject event images. In some implementations, the subject event image generator 269 can use the application session 308 to provide a conversational interface to facilitate generating useful subject event images, and the subject event image generator 269 can generate variations on useful subject event images to further facilitate configuration of the image models 278. For example, the application session 308, by being coupled with the subject event image generator 269, can receive input for the characteristics in any of various formats and data types, including unstructured (e.g., freeform) formats and any of text, audio, speech, image, and/or video data types, and use the subject event image generator 269 to process the inputs to identify the characteristics and generate the subject event images according to the characteristics. In an example, the model system 260 can receive input indicating a characteristic of an unsecured crane load above a person. In an example, the model system 260 can receive input indicating a characteristic of dangerous crane operation or a characteristic of dangers to persons from dangerous crane operation. The model system 260 can receive input indicating characteristic(s) associated with risk criteria for one or more persons and one or more objects in one or more scenes of a building environment, work site environment (e.g., construction environment), and/or a workplace environment. The subject event image generator 269 can implement various processes to provide transparency for generating the subject event images (e.g., by being configured to be queried for explanations of why the subject event images are generated in various ways), which can facilitate iteratively updating the subject event images until they satisfy a user's criteria in fewer iterations (e.g., using fewer computational resources).

In some embodiments, the subject event image generator 269 receives prompts 248 from the training management system 240, which may be provided by a user or generated automatically by the training management system 240, as previously described. The subject event image generator 269 may include one or more image generators and/or one or more video generators configured to generate the subject event images in response to the prompts 248. The prompts 248 may include prompts for generating images having one or more characteristics. The one or more characteristics can be associated with a condition, including, but not limited to, conditions that satisfy one or more risk criteria associated with a risk. The risk can be a risk to a person, building system, device, or piece of equipment. The subject event image generator 269 can generate the subject event images having the characteristics and/or representing the condition. In an example, the prompts 248 include a prompt to generate an image of a person engaging in risky behavior when welding or an image of a person violating one or more predefined rules for safe welding. In this example, the subject event image generator 269 can generate an image of a person welding without a face mask and/or an image of a person welding without wearing gloves. The subject event image generator 269 can generate several variants of a person welding without a face mask and/or of a person welding without wearing gloves. In another example, the prompts 248 include a prompt to generate an image of a fan with wiring that poses a spark risk. In this example, the subject event image generator 269 can generate images of a fan with improperly installed wiring, wiring with worn sheaths to expose wires, and/or wiring that has been chewed by rodents to expose wires, as well as several variants thereof.

The subject event generator 269 can generate subject event images having different, or opposite characteristics, or representing a different condition than in the prompts 248. In an example, the In an example, the prompts 248 include a prompt to generate an image of a person welding without a face mask. In this example, the machine learning models 268 can generate an image of a person welding without a face mask and an image of a person welding with a face mask. In an example, the prompts 248 include a prompt to generate an image of a fan with wiring that has been chewed by rodents. In this example, the machine learning models 268 can generate an image of wiring that has been chewed by rodents, an image of undamaged wiring, and an image of wiring that is worn but not chewed by rodents.

In some embodiments, the subject event image generator 269 generates the subject event images by isolating portions of actual images captured by the cameras 1002 or user devices 1004 at the building/work site 1000 or by other cameras unrelated to the building/work site 1000. For example, the subject event image generator 269 may search a repository of images (e.g., data repository 204, an online image archive, etc.) for images that depict various different types of subject events occurring in various settings. The subject event image generator 269 may retrieve relevant images depicting the subject events from one or more image sources or otherwise obtain such images as input data from a user or from the training management system 240. The subject event image generator 269 can be configured to isolate or extract portions of the images depicting the subject events. For example, the subject event image generator 269 can identify or create boundaries (e.g., boxes, curves, paths, etc.) defining a bounded area or shape within the images in which the subject events are depicted. In some embodiments, the subject event image generator 269 includes some or all of the functionality described in U.S. patent application Ser. No. 18/103,297 filed Jan. 30, 2023 (“the '297 application”), the entire disclosure of which is incorporated by reference herein. The subject event image generator 269 may use any of the techniques described in the '297 application to identify relevant portions of the images depicting the subject events and define boundaries around the relevant portions. The subject event image generator 269 may extract the relevant portions of the images to obtain focused images depicting the subject events in isolation or in a generic setting (e.g., with a blank background).

As noted above, the subject event images generated by the subject event image generator 269 may include images of the subject events in settings other than the building/work site 1000. For example, the subject event images may depict the subject events occurring in various different settings unrelated to the building/work site 1000 or abstracted from any setting (e.g., having a blank or generic background, having no background, etc.). The blended image generator 270 may be configured to combine or blend the subject event images with the background site images obtained from the cameras 1002 or user devices 1004 of the building/work site 1000 to generate blended images of the subject events occurring at the building/work site 1000. In some embodiments, the blended image generator 270 overlays the subject event images with the background site images to create the blended images. In some embodiments, the blended image generator 270 includes one or more AI models (e.g., generative AI models), machine learning models, neural network models, or other types of models configured to blend or combine the subject event images with the background site images to create realistic depictions of the subject events occurring at the building/work site 1000.

The blended image generator 270 may determine characteristics of the subject event images and/or the background site images to determine how to blend the subject event images with the background site images to generate the blended images. The blended image generator 270 may determine a size, perspective, angle, and other characteristics to determine how to blend the subject event images with the background site images. In an example, the blended image generator 270 determines a scale of the background site image to determine a size of a person in the blended image in order to size a person of the subject event image such that the person appears to be on the building/work site 1000 in the blended image. In an example, the blended image generator 270 determines a surface, such as the ground, in the background site image such that an object in the subject event image appears to be on the surface in the blended image. In an example, the blended image generator 270 determines a size, position, and shading for the subject event image to cause the subject event image to appear to be part of the background site image.

In some embodiments, the model system 260 generates a variety of synthetic images depicting the building/work site 1000 under a variety of different conditions which may or may not be depicted in the background site images obtained from the building/work site 1000. For example, the model system 260 may modify a real image from the building/work site 1000 in a variety of different ways to generate a set of synthetic images depicting how the building/work site 1000 would appear under different lighting conditions (e.g., daytime, nighttime, sunset or sunrise, indoor lights on, indoor lights off, different combinations of lights on/off, etc.), weather conditions (e.g., sunny, no clouds, cloudy or overcast, raining, snowing, windy, calm, etc.), or other environmental conditions which affect how the building/work site 1000 would appear from the perspective of cameras 1002 at various times of day, year, etc. to encompass a wide variety of temporal or seasonal variations. The model system 260 may supplement or replace the set of background site images obtained from the building/work site 1000 with the synthetic background site images generated in this manner to provide a robust set of background site images under varying conditions. The real and synthetic background site images can be used in the same manner by the model system 260 to generate blended subject event images of the subject event occurring at the building/work site 1000 under varying lighting or environmental conditions.

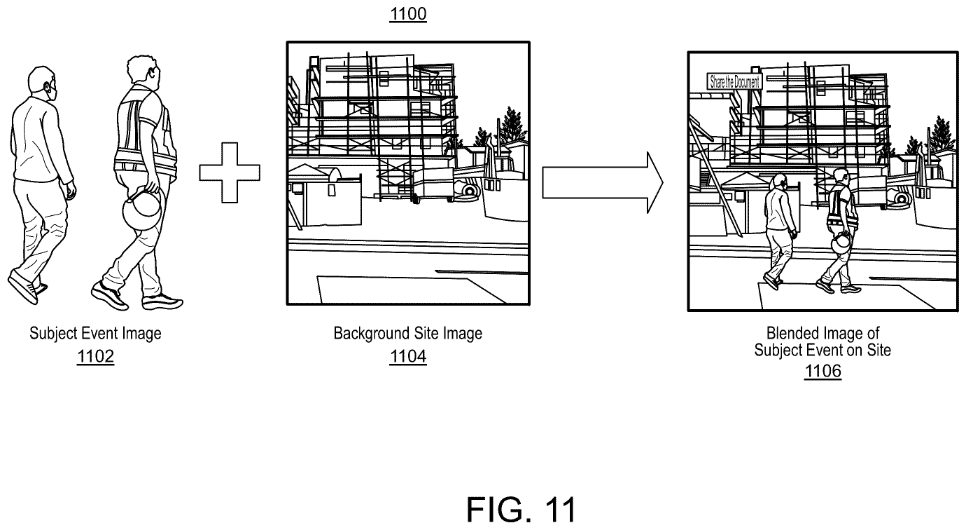

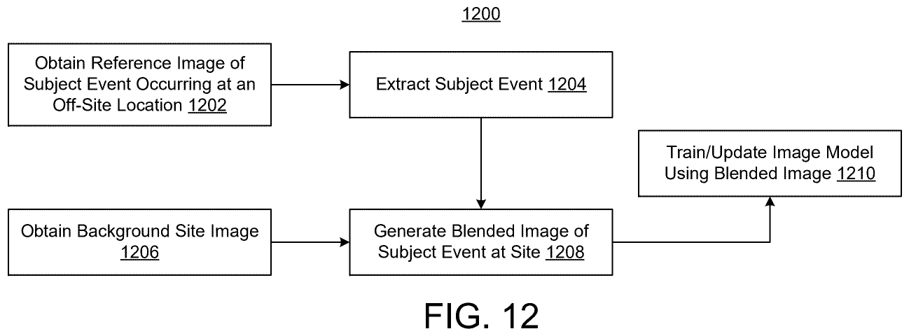

Referring now to FIGS. 11-12, two processes 1100 and 1200 illustrating the operation of the model system 260 are shown, according to exemplary embodiments. The process 1100 shown in FIG. 11 illustrates an example in which the subject event image generator 269 produces a subject event image 1102 showing construction workers not wearing a hard hat. In various embodiments, the subject event image 1102 can be a synthetic image generated by the subject event image generator 269 using one or more AI models (e.g., in response to the prompts 248) or can be a portion of an actual image (e.g., extracted or isolated from an actual image) as previously described. The blended image generator 270 obtains the background site image 1104, which is shown as a construction site in the absence of any workers. The blended image generator 270 then combines or blends the subject event image 1102 with the background site image 1104 to create the blended image 1106 illustrating the subject event occurring at the building/work site 1000. The blended image generator 270 may determine a ground surface in the background site image 1104 and a scale of one or more objects in the background site image 1104 in order to blend the subject event image 1102 with the background site image 1104 to create the blended image 1106. As illustrated, the blended image generator 270 scales and places the construction workers in the subject event image 1102 such that the construction workers appear to be walking on a road surface depicted in the background site image 1104 in the blended image 1106. The blended image generator 270 may determine the size and position of the construction workers based on objects in the background site image 1104 such as a fence, doorway, and/or construction equipment. In an example, the blended image generator 270 identifies the ground surface in the background site image 1104 based on a trailer and/or a fence in the background site image 1104 and determines a scale of the subject event image 1104 based on an estimated height of the construction workers, an estimated height of the trailer, and/or an estimated height of the fence.

The process 1200 shown in FIG. 12 illustrates an example in which the subject event image generator 269 obtains a reference image 1202 of a subject event occurring at an off-site location (e.g., at a setting or location other than the building/work site 1000 or the particular portion of the building/work site 1000 at which the subject event will be detected in the future). For example, the subject event image may depict a person falling from a safe distance in an outdoor setting (e.g., a park, a beach, into a swimming pool, etc.) or in a controlled environment in which the person is unlikely to be harmed from the fall (e.g., onto a mattress or padding). The subject event image generator 269 identifies the portion of the reference image 1202 depicting the subject event (e.g., person falling in space) and generates a boundary (e.g., a box, a curved path, etc.) around the identified portion of the reference image 1202. The subject event image generator 269 extracts the subject event 1204 from the reference image 1202 (e.g., the portion of the reference image 1202 within the boundary) to create a depiction of the subject event abstracted or isolated from the setting depicted in the reference image 1202. The blended image generator 270 obtains a background site image 1206, which depicts the background of the building/work site 1000 or the particular portion of the building/work site 1000 at which the subject event will be detected. The blended image generator 270 then combines or blends the extracted subject event 1204 with the background site image 1206 to create a blended image 1208 illustrating the subject event occurring at the building/work site 1000 (e.g., falling from scaffolding, falling out a window, etc.). The blended images 1208 and 1106 produced in processes 1200 and 1100 respectively may then be used to train or update an image model, such as image models 278, as shown in block 1210.

Referring again to FIG. 10, the blended images generated by the blended image generator 270 can be provided to the training management system 240 and stored as image data 258. In some embodiments, the image data 258 further includes labels applied to the blended images. For example, the labels may indicate the type of subject event depicted in the blended images (e.g., fire, hard hat violation, lack of gloves, etc.) and/or the building/work site 1000 in which the subject event is depicted. In some embodiments, the labels indicate the particular portions of the blended images that depict the subject events, which may be defined as boundaries around specified areas within the blended images. The labels can be stored as tags or other attributes of the blended images in the image data 258.

The training management system 240 can use the blended images and other image data 258 to train the image models 278 as described with reference to FIG. 2. For example, the training management system 240 can provide the image data 258 to the image model configuration processor 264. The image model configuration processor 264 can apply the image data 258 to the image models 278 to configure the image models 278. The training manager 244 can control training by the image model configuration processor 274 based on model tuning parameters in the model tuning database 256, such as to control various hyperparameters for training. In some embodiments, the image model system 272 is part of the model system 260, despite being shown separately in FIG. 10 for ease of explanation. In such an embodiment, the image models 278 can be included in the model system 260 and the model configuration processor 264 can apply the image data 258 to the image models 278 to configure the image models 278. In some embodiments, the image model configuration processor 274 and/or the model configuration processor 264 may apply the prompts 248 to the image models 278 and/or label the image data 258 with the prompts 248.

The image models 278 may include one or more AI models, neural network models, machine learning models, or other types of models configured to detect subject events in site images obtained from the building/work site 1000. In some embodiments, the image models 278 include a plurality of individual image models 278. Each individual image model 278 can be configured (e.g., trained) to detect a particular event or type of event and/or for a particular building/work site or type of building/work site. For example, one of the image models 278 may be trained to detect fires, another of the image models 278 may be trained to detect worker safety violations, and yet another of the image models 278 may be trained to detect faults in the equipment 1006. As another example, one of the image models 278 may be trained to detect subject events occurring at a construction site, another of the image models 278 may be trained to detect subject events occurring in an office building, and yet another of the image models 278 may be trained to detect subject events occurring in a factory or other industrial setting.

In other embodiments, a single image model 278 can be configured (e.g., trained) detect multiple different events or types of events and/or for multiple different building/work sites or types of building/work sites. It is contemplated that any number of the image models 278 can be generated and trained depending on the number of subject events the system 200 is configured to detect and/or the number of building/work sites 1000 for which the system 200 is deployed. Advantageously, training a larger number of individual image models 278 for different events/sites may allow each individual image model 278 to be more specialized and thus may provide a greater accuracy relative to a combined image model 278. Conversely, a combined image model 278 may be less accurate than multiple individual image models 278 in some scenarios, but may provide greater flexibility and reduce the number of image models 278 generated and stored in the system 200.

Still referring to FIG. 10, the building/work site 1000 is shown providing site images to the image model system 272. The site images may include new images captured by the cameras 1002 or user devices 1004 of the building/work site 1000. The new site images may be different than the background site images, subject event images, and/or blended images used to train the image models 278. The new site images may include still images, videos, or any combination thereof. The image model system 272 can use the image models 278 to detect subject events occurring at the building/work site 1000. For example, the image model system 272 may provide the site images as input to the image models 278 and may detect subject events occurring at the building/work site 1000 based on an output of the image models 278. In some embodiments, the image models 278 output a probability or likelihood that the site images provided as input depict a specified subject event or have a specified characteristic. In some embodiments, the image models 278 can be used to identify conditions associated with building management including, but not limited to, conditions that satisfy one or more risk criteria. For example, the image models 278 can be used to monitor video and detect risky behaviors and/or equipment malfunctions. In an example, the image models 278 identify a person welding without a face mask in a video. In another example, the image models 278 identify, from an image, wiring that has been chewed by rodents and which represents a fire or spark risk. The image model system 272 may output an indication of a detected event or condition to the risk monitoring system 1010.

The risk monitoring system 1010 may receive the indications of detected events or conditions (e.g., subject events) generated by the image model system 272. The risk monitoring system 1010 is shown to include an alarm generator 1012 and an automated intervention system 1014. The alarm generator 1012 can be configured to generate an alarm (e.g., an alert, a notification, a message, etc.) indicating the detected subject event. The alarm may indicate various attributes of the subject event such as the location of the subject event (e.g., identifying the building/work site 1000 and/or one or more spaces 1008 thereof), one or more devices of the equipment 1006 associated with the subject event (e.g., equipment experiencing a fault or likely to experience a fault in the future), a type of the subject event (e.g., fire, security event, faulty equipment, etc.), a time at which the subject event occurred or was detected, or any other attributes or details associated with the subject event. In some embodiments, the alarm indicates one or more actions to take in response to the subject event.

The alarm generator 1012 can distribute or transmit the alarm to one or more persons, groups of persons, automated systems, or other entity configured to record or take action in response to the alarm. The alarm generator 1012 can be configured to identify the appropriate person or group to which to transmit the alarm based on the type of alarm or location of the subject event. For example, if the subject event is a security event, the alarm generator 1012 can transmit the alarm to security personnel of the building/work site 1000. As another example, if the subject event indicates faulty operation of the equipment 1006, the alarm generator 1012 can transmit the alarm to maintenance personnel or service technicians responsible for maintaining or repairing the equipment 1006. In some embodiments, the alarm generator 1012 transmits the alarm to various users or groups based on their location and proximity to the location of the subject event. The alarm generator 1012 may include any or all of the functionality described in U.S. Pat. No. 10,667,096 granted on May 26, 2020, the entire disclosure of which is incorporated by reference herein.

The automated intervention system 1014 can automatically trigger (e.g., initiate, execute, perform, etc.) an intervention in response to detecting the subject event. The type of intervention triggered by the automated intervention system 1014 may depend on the type of subject event and/or the particular set of actions likely to resolve the alarm condition associated with the subject event. For example, if the subject event is a fire detected in a building space, the automated intervention system 1014 may trigger a building fire alarm (e.g., strobes, sirens, etc.) and/or a fire suppression system for the building/work site 1000 to suppress the fire. As another example, if the subject event indicates that the equipment 1006 are experiencing faulty operation (e.g., HVAC equipment leaking refrigerant, a mechanical failure, etc.), the automated intervention system 1014 may automatically shut down the equipment 1006 or modify their operation in response to the detected subject event. As another example, if the subject event indicates that a window or door of the spaces 1008 is stuck open, the automated intervention system 1014 may notify security personnel or other building occupants to close the window or door. It is contemplated that any number or type of automated interventions can be triggered by the automated intervention system 1014 depending on the type of detected event.

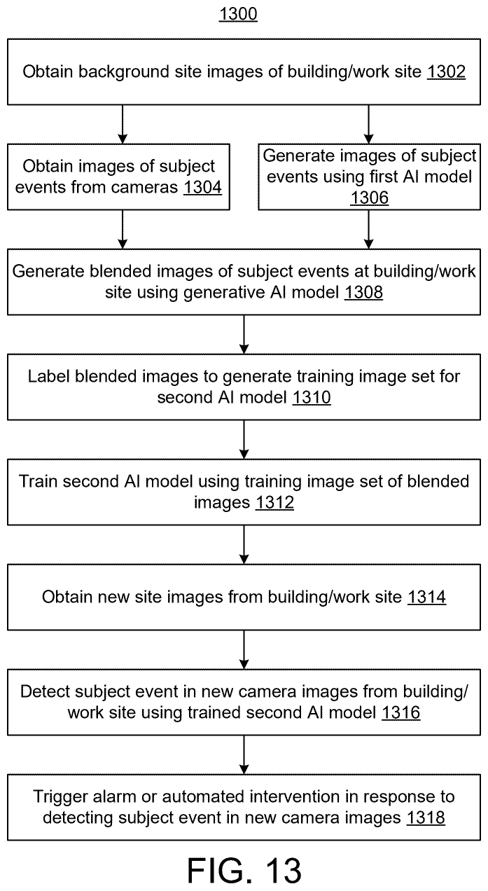

Referring now to FIG. 13, a flowchart of a process 1300 for detecting subject events using AI models, machine learning models, or neural network models is shown, according to an exemplary embodiment. The process 1300 can be performed using various devices and systems described herein, including but not limited to the systems 100, 200 or one or more components thereof. Various aspects of the process 1300 can be implemented using one or more devices or systems that are communicatively coupled with one another, including in client-server, cloud-based, or other networked architectures.

The process 1300 is shown to include obtaining background site images of a building/work site (step 1302). The background site images may include, for example, images of the building/work site 1000 in the absence of workers, temporary equipment, and/or other entities that are not present when the building/work site 1000 is not occupied or when subject events are not occurring at the building/work site 1000. For example, the background site images of an office building may include images of the spaces 1008 of the office building when unoccupied (e.g., without any employees or workers present). The background site images may include images of the equipment 1006 of the building/work site 1000 when the equipment 1006 are inactive or when the equipment 1006 are being used or operated under normal conditions (e.g., the absence of a fault or other detectable event occurring at the building/work site 1000). As another example, the background images of a factory or plant may include images of various spaces 1008 and/or equipment 1006 of the factory when the equipment 1006 are inactive and/or when the equipment 1006 are operating under normal conditions. As yet another example, the background images of a construction site may include images of various equipment 1006 and/or spaces 1008 of the construction site without any construction workers present, images of the equipment 1006 and/or spaces 1008 of the construction site when the equipment 1006 of the construction site are not being used, and/or images of equipment 1006 and/or spaces 1008 of the construction site when the equipment 1006 are being used or operated under normal conditions. In general, the background site images depict the background environment of the building/work site 1000 in the absence of events or other conditions that the system 200 is configured to detect (i.e., in the absence of subject events).

In some embodiments, the process 1300 includes obtaining images of subject events from cameras (step 1304). The cameras in step 1304 may include the cameras 1002 or user devices 1004 installed at the building/work site 1000 and/or other cameras unrelated to the building/work site 1000. Step 1304 may include isolating portions of actual images captured by the cameras. For example, step 1304 may include searching a repository of images (e.g., data repository 204, an online image archive, etc.) for images that depict various different types of subject event occurring in various settings. Step 1304 may include retrieving relevant images depicting the subject events from one or more image sources or otherwise obtaining such images as input data from a user or from the training management system 240. Step 1304 may include isolating or extracting portions of the images depicting the subject events. For example, step 1304 may include identifying or creating boundaries (e.g., boxes, curves, paths, etc.) defining a bounded area or shape within the images in which the subject events are depicted. Step 1304 may include using any of the techniques described in the '297 application (incorporated by reference above) to identify relevant portions of the images depicting the subject events and define boundaries around the relevant portions. Step 1304 may include extracting the relevant portions of the images to obtain focused images depicting the subject events in isolation or in a generic setting (e.g., with a blank background).

In some embodiments, the process 1300 includes generating images of the subject events using a first AI model (step 1306). Step 1306 may be performed in addition to or in place of step 1304 to generate the images depicting the subject events. The first AI model used in step 1306 may be a component of the subject event image generator 269 as described with reference to FIG. 10. Step 1306 may include generating synthetic or simulated images having one or more characteristics representative of conditions or events which could occur at the building/work site 1000, such as conditions or events satisfying one or more risk criteria. For example, step 1306 may include receiving (e.g., via the application session 308), an input indicating one or more characteristics for generating the subject event images. In some implementations, step 1306 includes using the application session 308 to provide a conversational interface to facilitate generating useful subject event images. Step 1306 may include generating variations on useful subject event images to further facilitate configuration of the image models 278. For example, step 1306 may include receiving input for the characteristics in any of various formats and data types, including unstructured (e.g., freeform) formats and any of text, audio, speech, image, and/or video data types, and using the subject event image generator 269 to process the inputs to identify the characteristics and generate the subject event images according to the characteristics. Step 1306 may include implementing various processes to provide transparency for generating the subject event images (e.g., by being configured to be queried for explanations of why the subject event images are generated in various ways), which can facilitate iteratively updating the subject event images until they satisfy a user's criteria in fewer iterations (e.g., using fewer computational resources).

In some embodiments, step 1306 includes receiving prompts 248 from the training management system 240, which may be provided by a user or generated automatically by the training management system 240, as previously described. Step 1306 includes may include using one or more image generators and/or one or more video generators configured to generate the subject event images in response to the prompts 248. The prompts 248 may include prompts for generating images having one or more characteristics. The one or more characteristics can be associated with a condition, including, but not limited to, conditions that satisfy one or more risk criteria associated with a risk. The risk can be a risk to a person, building system, device, or piece of equipment. Step 1306 may include generating the subject event images having the characteristics and/or representing the condition. In an example, the prompts 248 include a prompt to generate an image of a person engaging in risky behavior when welding or an image of a person violating one or more predefined rules for safe welding. In this example, step 1306 includes can generate an image of a person welding without a face mask and/or an image of a person welding without wearing gloves. Step 1306 includes may include generating several variants of a person welding without a face mask and/or of a person welding without wearing gloves. In another example, the prompts 248 include a prompt to generate an image of a fan with wiring that poses a spark risk. In this example, step 1306 may include generating images of a fan with improperly installed wiring, wiring with worn sheaths to expose wires, and/or wiring that has been chewed by rodents to expose wires, as well as several variants thereof.

The process 1300 is shown to include generating blended images of subject events occurring at the building/work site using a generative AI model (step 1308). In some embodiments, the subject event images generated in steps 1304 or 1306 include images of the subject events in settings other than the building/work site 1000. For example, the subject event images may depict the subject events occurring in various different settings unrelated to the building/work site 1000 or abstracted from any setting (e.g., having a blank or generic background, having no background, etc.). Accordingly, step 1308 may be performed to create blended images that depict the subject events occurring at the building/work site 1000.

In some embodiments, step 1308 includes combining or blending the subject event images generated in steps 1304 or 1306 with the background site images obtained in step 1302 to generate blended images of the subject events occurring at the building/work site 1000. In some embodiments, step 1308 includes overlaying the subject event images with the background site images to create the blended images. In some embodiments, step 1308 includes using one or more AI models (e.g., generative AI models), machine learning models, neural network models, or other types of models configured to blend or combine the subject event images with the background site images to create realistic depictions of the subject events occurring at the building/work site 1000. In various embodiments, the AI model used in step 1308 may be the same as or different than the first AI model used in step 1306 to generate the synthetic images of the subject events and/or the second AI model used in subsequent steps of the process 1300.

The process 1300 is shown to include labeling blended images to generate a training image set for a second AI model (step 1310). Step 1310 may include applying labels or tags to the blended images or otherwise storing labels associated with the blended images. The labels may indicate the type of subject event depicted in the blended images (e.g., fire, hard hat violation, lack of gloves, etc.) and/or the building/work site 1000 in which the subject event is depicted. In some embodiments, the labels indicate the particular portions of the blended images that depict the subject events, which may be defined as boundaries around specified areas within the blended images. The labels can be stored as tags or other attributes of the blended images in the image data 258, or otherwise associated with the blended images.

The process 1300 is shown to include training the second AI model using the training image set of blended images (step 1312). Step 1312 may include using the blended images generated in step 1308 and the applied labels or tags generated in step 1310 to train the second AI model (e.g., image models 278). In some embodiments, step 1312 is performed by the training management system 240. For example, the training management system 240 can provide the image data 258 to the image model configuration processor 264. The image model configuration processor 264 can apply the image data 258 to the image models 278 to configure the image models 278. Step 1312 can include controlling training by the image model configuration processor 274 based on model tuning parameters in the model tuning database 256, such as to control various hyperparameters for training. In some embodiments, step 1312 includes applying the prompts 248 to the image models 278 and/or labeling the image data 258 with the prompts 248.

The second AI model trained in step 1312 (e.g., image models 278) may include one or more AI models, neural network models, machine learning models, or other types of models configured to detect subject events in site images obtained from the building/work site 1000. In some embodiments, the second AI model includes a plurality of individual image models. Each individual image model can be configured (e.g., trained) to detect a particular event or type of event and/or for a particular building/work site or type of building/work site. For example, one of the image models may be trained to detect fires, another of the image models may be trained to detect worker safety violations, and yet another of the image models may be trained to detect faults in the equipment 1006. As another example, one of the image models may be trained to detect subject events occurring at a construction site, another of the image models may be trained to detect subject events occurring in an office building, and yet another of the image models may be trained to detect subject events occurring in a factory or other industrial setting.

In other embodiments, the second AI model trained in step 1312 may include a single image model 278 configured (e.g., trained) detect multiple different events or types of events and/or for multiple different building/work sites or types of building/work sites. It is contemplated that any number of the image models 278 can be generated and trained in step 1312 depending on the number of subject events the process 1300 is configured to detect and/or the number of building/work sites 1000 for which the process 1300 is deployed. Advantageously, training a larger number of individual image models 278 for different events/sites may allow each individual image model 278 to be more specialized and thus may provide a greater accuracy relative to a combined image model 278. Conversely, a combined image model 278 may be less accurate than multiple individual image models 278 in some scenarios, but may provide greater flexibility and reduce the number of image models 278 generated and stored in the process 1300.

The process 1300 is shown to include obtaining new site images from the building/work site (step 1314). The new site images may include new images captured by the cameras 1002 or user devices 1004 of the building/work site 1000. The new site images may be different than the background site images obtained in step 1302, the subject event images obtained or generated in steps 1304 or 1306, and/or the blended images generated in step 1308 and used to train the second AI model in step 1312. The new site images may include still images, videos, or any combination thereof.

The process 1300 is shown to include detecting a subject event in the new camera images from building/work site using the trained second AI model (step 1316). Step 1316 can include using the second AI model to detect various subject events occurring at the building/work site 1000. Step 1316 may include providing the site images as input to the second AI model and detecting subject events occurring at the building/work site 1000 based on an output of the second AI model. In some embodiments, the second AI model outputs a probability or likelihood that the new site images provided as input depict a specified subject event or have a specified characteristic. In some embodiments, step 1316 includes using the second AI model to identify conditions associated with building management including, but not limited to, conditions that satisfy one or more risk criteria. For example, step 1316 may include monitoring video and detecting risky behaviors and/or equipment malfunctions. In an example, the second AI model can identify a person welding without a face mask in a video. In another example, the second AI model can identify, from an image, wiring that has been chewed by rodents and which represents a fire or spark risk. Step 1316 may include outputting an indication of a detected event or condition.

The process 1300 is shown to include triggering an alarm or automated intervention in response to detecting the subject event in the new camera images (step 1318). The alarm may include an alert, a notification, a message, or other indication of the detected subject event. The alarm may indicate various attributes of the subject event such as the location of the subject event (e.g., identifying the building/work site 1000 and/or one or more spaces 1008 thereof), one or more devices of the equipment 1006 associated with the subject event (e.g., equipment experiencing a fault or likely to experience a fault in the future), a type of the subject event (e.g., fire, security event, faulty equipment, etc.), a time at which the subject event occurred or was detected, or any other attributes or details associated with the subject event. In some embodiments, the alarm indicates one or more actions to take in response to the subject event.

Step 1318 can include distributing or transmitting the alarm to one or more persons, groups of persons, automated systems, or other entity configured to record or take action in response to the alarm. In some embodiments step 1318 includes identifying the appropriate person or group to which to transmit the alarm based on the type of alarm or location of the subject event. For example, if the subject event is a security event, step 1318 can transmit the alarm to security personnel of the building/work site 1000. As another example, if the subject event indicates faulty operation of the equipment 1006, step 1318 can transmit the alarm to maintenance personnel or service technicians responsible for maintaining or repairing the equipment 1006. In some embodiments, step 1318 includes transmitting the alarm to various users or groups based on their location and proximity to the location of the subject event. Step 1318 may include performing one or more of the location-based or role-based alert distribution functions described in U.S. Pat. No. 10,667,096 granted on May 26, 2020, the entire disclosure of which is incorporated by reference herein.

In some embodiments, step 1318 includes automatically triggering (e.g., initiating, executing, performing, etc.) an intervention in response to detecting the subject event. The type of intervention triggered in step 1318 may depend on the type of subject event and/or the particular set of actions likely to resolve the alarm condition associated with the subject event. For example, if the subject event is a fire detected in a building space, step 1318 may include triggering a building fire alarm (e.g., strobes, sirens, etc.) and/or a fire suppression system for the building/work site 1000 to suppress the fire. As another example, if the subject event indicates that the equipment 1006 are experiencing faulty operation (e.g., HVAC equipment leaking refrigerant, a mechanical failure, etc.), step 1318 may include automatically shutting down the equipment 1006 or modifying their operation in response to the detected subject event. As another example, if the subject event indicates that a window or door of the spaces 1008 is stuck open, step 1318 may include notifying security personnel or other building occupants to close the window or door. It is contemplated that any number or type of automated interventions can be triggered in step 1318 depending on the type of detected event.

### VI. Example Use Cases and Improvements

It is contemplated that the system 200 and the process 1300 described herein can be used in a variety of different settings (e.g., in various industries, buildings, types of building/work site 1000, etc.) to detect a variety of different subject events occurring at the corresponding building/work site 1000. For example, the system 200 and the process 1300 can be used in industries such as construction (e.g., at construction sites for buildings, shipyards, indoor or outdoor construction projects), manufacturing (e.g., factories, assembly plants, product fabrication facilities, etc.), oil and gas (e.g., oil/gas rigs, oil/gas processing or refining plants, oil/gas pipelines, etc.), mining (e.g., indoor or outdoor dig sites, subterranean mining locations, ore refineries, metal or mineral processing facilities, etc.), chemical manufacturing or processing (e.g., chemical plants, chemical processing facilities, water treatment facilities, etc.), healthcare (e.g., hospitals, healthcare clinics, medical office buildings, veterinarian facilities, etc.), food processing (e.g., food processing plants, food preparation facilities, etc.), transportation (e.g., airplanes or airports, trains or train stations, boats or docks, shipyards, subways, parking lots, etc.), waste management (e.g., garbage processing sites, recycling sites, landfills, etc.), agriculture (e.g., farms, greenhouses, barns, etc.), warehouses (e.g., warehouse retail stores, industrial warehouses, product fulfillment centers, etc.), commercial facilities (e.g., office buildings, stores, retail locations, etc.), education (e.g., schools, colleges, campuses, etc.), equipment sites (e.g., HVAC rooms or sites, central utility plants, elevator rooms, server rooms, etc.), or any other type of industry or setting.

While the foregoing set of examples is provided to illustrate a wide variety of potential implementations of the system 200 and the process 1300, it should be understood that the systems and methods described herein are not limited to these specific implementations. Rather, it is contemplated that the system 200 and the process 1300 can be applied to virtually any setting in which it may be desirable to detect certain types of events. For example, the system 200 and the process 1300 can be used in any industry or setting which mandates that employees or other persons wear personal protective equipment (PPE) and/or in which potentially unsafe working conditions may occur. Several non-limiting examples of how the system 200 and the process 1300 can be used to detect various types of subject events in such settings are described below.

One example of a subject event which can be detected the system 200 and the process 1300 is a person falling from height (e.g., from scaffolding, a balcony, out of a window, or from any other elevated location). This type of subject event may occur, for example, at a construction site, a maintenance site, a building with multiple floors or balconies, or any other location where a person may be at risk of falling. Model system 260 can generate or otherwise obtain subject event images depicting a person falling from height. In some embodiments, such subject event images may be generated by providing the subject event image generator 269 with a prompt such as “generate one hundred images of a person falling from height in various settings.” The subject event image generator 269 may then generate synthetic images of a person falling from various types of objects, locations, platforms, etc. with a variety of different backgrounds, lighting conditions, weather or seasonal variations, etc. to generate a robust set of synthetic images for use in training the image models 278. In other embodiments, the subject event image generator 269 may search for subject event images depicting a person falling in public databases, internet webpages, or other locations where such image data may be present. The blended image generator 270 may identify and extract the portions of the subject images which depict the person falling and blend the extracted portions of the subject images with background site images of the building/work site 1000 at which the system 200 or process 1300 will be implemented to generate blended subject event images depicting the subject event at the building/work site 1000. The blended subject event images can then be used to train the image models to detect a person falling at the location of the building/work site 1000.

Another example of a subject event which can be detected the system 200 and the process 1300 is a person working near heavy equipment or in a potentially dangerous setting without wearing proper safety gear (e.g., a hardhat, safety vest, eye protection, gloves, etc.) appropriate for the type of work the person is performing. This type of subject event may occur, for example, at a construction site (e.g., hardhat and vest required for construction workers, gloves and closed-toe shoes required for welders, etc.), a mine (e.g., miners working without proper respiratory equipment), a factory or plant (e.g., factory workers operating heavy equipment while a person is nearby, a person located in an equipment operating zone, etc.), a warehouse (e.g., a worker operating a forklift or vehicle at an unsafe speed or without wearing a seatbelt), or any other location where a potentially dangerous or hazardous condition may occur. Model system 260 can generate or otherwise obtain subject event images depicting these types of subject events. In some embodiments, the subject event images may be generated by providing the subject event image generator 269 with a prompt such as “generate one hundred images of a construction worker without a hardhat,” “generate fifty images of a welder operating without a mask or gloves,” “generate twenty videos of a person driving a forklift over ten miles per hour,” or any other prompt suitable for generating synthetic images of the desired subject event. The subject event image generator 269 may then generate synthetic images (e.g., still images or videos) of the specified types of subject events with a variety of different backgrounds, lighting conditions, weather or seasonal variations, etc. to generate a robust set of synthetic images for use in training the image models 278. In other embodiments, the subject event image generator 269 may search for subject event images depicting these types of subject events in public databases, internet webpages, or other locations where such image data may be present. The blended image generator 270 may identify and extract the portions of the subject images which depict the potentially unsafe condition or event and blend the extracted portions of the subject images with background site images of the building/work site 1000 at which the system 200 or process 1300 will be implemented to generate blended subject event images depicting the subject event at the building/work site 1000. The blended subject event images can then be used to train the image models to detect the specified subject event at the location of the building/work site 1000.

Another example of a subject event which can be detected the system 200 and the process 1300 is a person not wearing gloves, a mask, or other PPE mandated by the setting or activity. This type of subject event may occur, for example, at a hospital or medical facility (e.g., gloves and mask required for doctors, nurses, visitors, or patients). Model system 260 can generate or otherwise obtain subject event images depicting a person not wearing appropriate PPE. In some embodiments, the subject event images may be generated by providing the subject event image generator 269 with a prompt such as “generate one hundred images of a doctor or nurse not wearing a mask” or “generate fifty videos of a person entering a room without wearing gloves.” The subject event image generator 269 may then generate synthetic images (e.g., still images or videos) of people not wearing masks or gloves with a variety of different backgrounds, lighting conditions, weather or seasonal variations, etc. to generate a robust set of synthetic images for use in training the image models 278. In other embodiments, the subject event image generator 269 may search for subject event images depicting a person not wearing a mask or gloves in public databases, internet webpages, or other locations where such image data may be present. The blended image generator 270 may identify and extract the portions of the subject images which depict a person not wearing a mask or gloves and blend the extracted portions of the subject images with background site images of the building/work site 1000 (e.g., the hospital, clinic, etc.) at which the system 200 or process 1300 will be implemented to generate blended subject event images depicting the subject event at the building/work site 1000. The blended subject event images can then be used to train the image models to detect a person not wearing appropriate PPE at the location of the building/work site 1000.

The system 200 and the process 1300 described herein provide several improvements to the technical fields of risk monitoring systems, building management systems, and synthetic image generation systems. For example, one improvement is that the system 200 and the process 1300 can be used to generate a more robust (e.g., diverse, complete, etc.) set of training images for the image model system 272 than would be possible using prior techniques. This improvement is achieved by using the subject event image generator 269 to generate a wide variety of depictions of a specified subject event that encompasses many different visual appearances of the subject event (e.g., under different lighting conditions, variations in environment, variations in equipment, variations in weather, etc.). This allows the image model system 272 to learn to detect the subject event under a wide variety of conditions or other environmental factors that may be present at the building/work site 1000 at different times.

Another improvement provided by the system 200 and the process 1300 is that training images can be generated for various types of subject events that are dangerous or may result in harm to a person (e.g., a person falling from height, a person being hit by a car, etc.) notwithstanding the fact that existing AI-based synthetic generation systems often refuse to generate such images. This improvement is achieved by obtaining real images of the subject events or generating synthetic images of the subject events occurring in settings that are not dangerous (e.g., a person falling from low height onto a mattress), extracting the relevant portions of the images depicting the subject event, and blending the extracted portions of the images with background site images of the building/work site 1000. The resulting images may depict the subject events occurring in settings that are dangerous or may result in harm to a person without requiring an existing AI-based image generation system to violate its restrictions against generating images that depict such events.

Another improvement provided by the system 200 and the process 1300 is that the set of training image data used to train the image models 278 can be customized to the particular building/work site 1000 at which the system 200 and the process 1300 will be implemented. This improvement is achieved by creating a set of blended training data images (i.e., the blended images described herein) that depict a specified subject event occurring at a particular building/work site 1000 by blending images of the subject event with real or synthetic images of the building/work site 1000. The resulting set of training images allow the image model system 272 to be more accurate and finely tuned to detect the subject event occurring at the building/work site 1000 because the training images will closely match the actual images the cameras 1002 will see when implemented at the building/work site 1000.

Another improvement provided by the system 200 and the process 1300 is that the risk monitoring system 1010 can accurately detect a specified subject event occurring at the building/work site 1000 and automatically generate an alarm and/or initiate an automated intervention appropriate to address or correct an anomalous or risky condition indicated by the detected subject event. For example, if the subject event is a fire detected in a building space, the automated intervention may include triggering a building fire alarm (e.g., strobes, sirens, etc.) and/or a fire suppression system for the building/work site 1000 to suppress the fire. As another example, if the subject event indicates that the equipment 1006 are experiencing faulty operation (e.g., HVAC equipment leaking refrigerant, a mechanical failure, etc.), the automated intervention may include automatically shutting down the equipment 1006 or modifying their operation in response to the detected subject event. As another example, if the subject event indicates that a window or door of the spaces 1008 is stuck open, the automated intervention may include notifying security personnel or other building occupants to close the window or door. It is contemplated that any number or type of automated interventions can be triggered by the system 200 or the process 1300 depending on the type of detected event.

### VII. Configuration of Exemplary Embodiments

The construction and arrangement of the systems and methods as shown in the various exemplary embodiments are illustrative only. Although only a few embodiments have been described in detail in this disclosure, many modifications are possible (e.g., variations in sizes, dimensions, structures, shapes and proportions of the various elements, values of parameters, mounting arrangements, use of materials, colors, orientations, etc.). For example, the position of elements may be reversed or otherwise varied and the nature or number of discrete elements or positions may be altered or varied. Accordingly, all such modifications are intended to be included within the scope of the present disclosure. The order or sequence of any process or method steps may be varied or re-sequenced according to alternative embodiments. Other substitutions, modifications, changes, and omissions may be made in the design, operating conditions and arrangement of the exemplary embodiments without departing from the scope of the present disclosure.

The present disclosure contemplates methods, systems and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, CD-ROM or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. When information is transferred or provided over a network or another communications connection (either hardwired, wireless, or a combination of hardwired or wireless) to a machine, the machine properly views the connection as a machine-readable medium. Thus, any such connection is properly termed a machine-readable medium. Combinations of the above are also included within the scope of machine-readable media. Machine-executable instructions include, for example, instructions and data which cause a general purpose computer, special purpose computer, or special purpose processing machines to perform a certain function or group of functions.

Although the figures show a specific order of method steps, the order of the steps may differ from what is depicted. Also, two or more steps may be performed concurrently or with partial concurrence. Such variation will depend on the software and hardware systems chosen and on designer choice. All such variations are within the scope of the disclosure. Likewise, software implementations could be accomplished with standard programming techniques with rule based logic and other logic to accomplish the various connection steps, processing steps, comparison steps and decision steps.

In various implementations, the steps and operations described herein may be performed on one processor or in a combination of two or more processors. For example, in some implementations, the various operations could be performed in a central server or set of central servers configured to receive data from one or more devices (e.g., edge computing devices/controllers) and perform the operations. In some implementations, the operations may be performed by one or more local controllers or computing devices (e.g., edge devices), such as controllers dedicated to and/or located within a particular building or portion of a building. In some implementations, the operations may be performed by a combination of one or more central or offsite computing devices/servers and one or more local controllers/computing devices. All such implementations are contemplated within the scope of the present disclosure. Further, unless otherwise indicated, when the present disclosure refers to one or more computer-readable storage media and/or one or more controllers, such computer-readable storage media and/or one or more controllers may be implemented as one or more central servers, one or more local controllers or computing devices (e.g., edge devices), any combination thereof, or any other combination of storage media and/or controllers regardless of the location of such devices.

What is claimed is:

1. A method comprising:
obtaining, by one or more processors, a background image of a building/work site;
obtaining, by the one or more processors, a subject image depicting a subject event;
generating, by the one or more processors using a generative artificial intelligence (AI) model, a blended image by combining the subject image with the background image, the blended image depicting the subject event occurring at the building/work site; and
providing, by the one or more processors, the blended image as training data input to at least one neural network to configure the at least one neural network using the blended image.

2. The method of claim 1, wherein obtaining the subject image comprises generating the subject image using a second generative AI model.

3. The method of claim 2, wherein generating the subject image using the second generative AI model comprises:
receiving a prompt comprising one or more risk criteria describing a risk associated with a person, building system, device, or piece of equipment;
providing the prompt as input to the second generative AI model; and
generating the subject image as an output of the second generative AI model in response to the prompt.

4. The method of claim 1, wherein obtaining the subject image comprises:
obtaining a reference image depicting the subject event occurring at a location other than the building/work site;
identifying a portion of the reference image depicting the subject event; and
extracting the portion of the reference image depicting the subject event.

5. The method of claim 1, further comprising labeling, by the one or more processors, the subject image or the blended image with one or more tags or attributes identifying at least one of the subject event depicted in the subject image or the blended image or a boundary defining a portion of the subject image or the blended image depicting the subject event.

6. The method of claim 1, further comprising:
obtaining, by the one or more processors, new camera images from the building/work site;
providing, by the one or more processors, the new camera images as input to the at least one neural network; and
detecting, by the one or more processors, the subject event occurring at the building/work site based on an output of the neural network provided responsive to the new camera images.

7. The method of claim 6, further comprising triggering, by the one or more processors, an alarm in response to detecting the subject event in the new camera images.

8. The method of claim 7, wherein triggering the alarm comprises:
identifying a person or group responsible for addressing the alarm based on a type of the alarm and a role of the person or group; and
transmitting the alarm to the identified person or group responsible for addressing the alarm.

9. The method of claim 6, further comprising triggering, by the one or more processors, an automated intervention in response to detecting the subject event in the new camera images.

10. The method of claim 9, wherein the subject event comprises faulty operation of building equipment and the automated intervention comprises adjusting an operation of the building equipment in response to detecting the faulty operation.

11. A system comprising:
one or more processors; and
one or more non-transitory computer-readable media storing instructions that, when executed by the one or more processors, cause the one or more processors to perform operations comprising:
obtaining a background image of a building/work site;
obtaining a subject image depicting a subject event;
generating, using a generative artificial intelligence (AI) model, a blended image by combining the subject image with the background image, the blended image depicting the subject event occurring at the building/work site; and
providing the blended image as training data input to at least one neural network to configure the at least one neural network using the blended image.

12. The system of claim 11, wherein obtaining the subject image comprises generating the subject image using a second generative AI model.

13. The system of claim 12, wherein generating the subject image using the second generative AI model comprises:
receiving a prompt comprising one or more risk criteria describing a risk associated with a person, building system, device, or piece of equipment;
providing the prompt as input to the second generative AI model; and
generating the subject image as an output of the second generative AI model in response to the prompt.

14. The system of claim 11, wherein obtaining the subject image comprises:
obtaining a reference image depicting the subject event occurring at a location other than the building/work site;
identifying a portion of the reference image depicting the subject event; and
extracting the portion of the reference image depicting the subject event.

15. The system of claim 11, the operations further comprising labeling the subject image or the blended image with one or more tags or attributes identifying at least one of the subject event depicted in the subject image or the blended image or a boundary defining a portion of the subject image or the blended image depicting the subject event.

16. The system of claim 11, the operations further comprising:
obtaining new camera images from the building/work site;
providing the new camera images as input to the at least one neural network; and
detecting the subject event occurring at the building/work site based on an output of the neural network provided responsive to the new camera images.

17. The system of claim 16, the operations further comprising triggering an alarm in response to detecting the subject event in the new camera images.

18. The system of claim 17, wherein triggering the alarm comprises:
identifying a person or group responsible for addressing the alarm based on a type of the alarm and a role of the person or group; and
transmitting the alarm to the identified person or group responsible for addressing the alarm.

19. The system of claim 16, the operations further comprising triggering an automated intervention in response to detecting the subject event in the new camera images.

20. The system of claim 19, wherein the subject event comprises faulty operation of building equipment and the automated intervention comprises adjusting an operation of the building equipment in response to detecting the faulty operation.
